(19) United States
(12) Patent Application Publication
(10) Pub. No.: US 2005/0273363 A1
(43) Pub. Date: Dec. 8, 2005

(54) System and method for management of medical and encounter data

(75) Inventors: Randolph B. Lipscher, Austin, TX (US); Eric Wohl, Austin, TX (US); Michael Dahlin, Austin, TX (US); Borislav Portman, Austin, TX (US)

Correspondence Address: TOLER & LARSON & ABEL L.L.P., 5000 PLAZA ON THE LAKE STE 265, AUSTIN, TX, 78746, US

(73) Assignee: CATALIS, INC., Austin, TX (US)

(21) Appl. No.: 11/143,892

(22) Filed: Jun. 2, 2005

Related U.S. Application Data
(60) Provisional application No. 60/576,247, filed on Jun. 2, 2004.
(60) Provisional application No. 60/637,591, filed on Dec. 20, 2004.

(51) Int. Cl. G06F 17/60

(52) U.S. Cl. 705/2

(57) ABSTRACT

The disclosure is directed to a method of facilitating a medical workflow. The method includes receiving patient data via a first user interface device; providing a first medical data entry interface to a second user interface device; and providing a second medical data entry interface to the second user interface device in response to the selection of one selectable item of at least two selectable items. The first medical data entry interface includes at least a portion of the patient data and at least two selectable items. Each selectable item of the at least two selectable items is associated with a different stage within the medical workflow. The second medical data entry interface is configured to receive data associated with the stage within the medical workflow associated with the one selected selectable item.

### CROSS-REFERENCE TO RELATED APPLICATION(S)

The present application claims priority from U.S. Provisional Patent Application No. 60/576,247, filed Jun. 2, 2004, entitled “SYSTEM AND METHOD FOR MANAGEMENT OF MEDICAL AND ENCOUNTER DATA,” naming inventors Randolph B. Lipscher, Eric Wohl, and Michael Dahlin, which application is incorporated by reference herein in its entirety.

The present application claims priority from U.S. Provisional Patent Application No. 60/637,591, filed Dec. 20, 2004, entitled “SYSTEM AND METHOD FOR MANAGEMENT OF MEDICAL ENCOUNTER DATA,” naming inventors Randolph B. Lipscher, Eric Wohl, and Boris Portman, which application is incorporated by reference herein in its entirety.

### TECHNICAL FIELD OF THE DISCLOSURE

This disclosure, in general, relates to systems and methods for managing medical encounter data.

### BACKGROUND

Each medical encounter, such as an encounter between a doctor and a patient or between a nurse and a patient, results in medical findings. Medical findings include symptoms, conditions, patient data, test results, diagnoses, and prescriptions. These medical findings may be useful in cataloging a patient medical history, determining coding for insurance or payer purposes, and performing medical research. To manage medical findings data, medical professionals are increasingly turning to computer systems and software. However, typical systems interface poorly with the workflow of a physician.

Paper charts have been used to record medical findings data during encounters with patients. The medical findings data is manually entered into a computer by office staff after the patient departs. Such systems are slow and prone to error. In addition, physicians and medical facilities, such as hospitals, incur the added expense of having data entry personnel, often without medical training, enter medical findings into computer systems. As such, the data entry is typically inaccurate and costly.

Moreover, medical findings data associated with past encounters are often unavailable or limited. In the typical paper charting system, physicians must review each of a set of past charts to discern medical history and, generally, do not have access to a computer during the patient visit. As such, these typical systems provide poor visibility into patient medical, social, and pharmaceutical history.

An incomplete view of a patient's medical history may adversely affect a doctor's diagnoses and medical opinions, potentially leading to errors and malpractice claims. As such, there is a need for improved systems and methods for managing medical encounter data.

### BRIEF DESCRIPTION OF THE DRAWINGS

FIG. 1 illustrates an exemplary embodiment of a system for managing medical encounter data.

FIG. 2 illustrates an exemplary embodiment of an interface system.

FIG. 3 illustrates an exemplary embodiment of an encounter system.

FIG. 4 illustrates an exemplary medical workflow.

FIGS. 5, 6A, and 6B illustrate exemplary interfaces.

FIG. 7 illustrates an exemplary method for facilitating a medical workflow.

FIGS. 8, 9, 10, 11, 12, 13, 14A, 14B, 14C, 14D, 14E, 14F, 15, 16, 17, 18A, 18B, 18C, 19, 20, 21, and 22 illustrate exemplary embodiments of medical data entry interfaces.

FIG. 23 depicts an exemplary embodiment of a medical data entry interface device.

FIGS. 24, 25, 26, 27, 28, 29, 30, 31, 32, 33, 34, 35, 36, 37, and 38 illustrate exemplary embodiments of a medical data entry interface.

FIGS. 39, 40, 41, 42, 43, 44, 45, 46, 47, 48, 49, 50, 51, 52, 53, 54, and 55 illustrate exemplary interfaces for medical data entry.

FIGS. 56 through 88 illustrate alternative embodiments of exemplary interfaces.

FIGS. 89 through 97 include illustrations of exemplary embodiment of medical data entry interfaces.

### DESCRIPTION OF THE DRAWING(S)

In a particular embodiment, the disclosure is directed to a computer system that includes several interface devices that function to gather information and store that information in a central encounter system. The interface devices selectively present specific interfaces for gathering encounter information, such as medical findings data, and providing it to the encounter system. The encounter system provides this information through the interfaces to permit collecting additional encounter information and performing further tasks associated with a medical workflow. In one exemplary embodiment, the computational interface devices include wireless computational devices, which gather information through specific interfaces such as patient interfaces, nurse interfaces, and physician interfaces and provide that information to a centralized encounter system. The encounter system may also augment the information with data provided from external resources and practice management systems.

In another exemplary embodiment, the disclosure is directed to a medical data entry interface and systems for implementing that interface that display a face sheet for use in a medical encounter workflow. The face sheet generally includes a summary of vitals information and patient social family and medical history information that may be provided by the patient or collected by other medical professionals, such as nurses, prior to a medical encounter with a physician. In one exemplary embodiment, the face sheet shows vitals information such as temperature, blood pressure, heart rate, respiratory rate, blood oxygenation, height, weight, and HC. Those vitals that are abnormal may be highlighted or encapsulated with a color-coded indication. Alternatively, those vitals that have not been collected may be highlighted or color-coded.

The face sheet may also include information about prescription drug allergies, chief complaint, and history of present illness, which is collected prior to a physician's visit. For example, information on vitals, drug allergies, chief complaint, and history of present illness may be collected from the patient in the waiting room or by a nurse visiting the patient prior to the physician.

In one exemplary embodiment, the chief complaint and history of present illness data are accompanied by a medical narrative. The face sheet may also provide an indication regarding when the last note was prepared for this patient and a link to past notes. In addition, the face sheet may include information regarding new medications and current medications being taken by a patient, medical and surgical histories, test and order results, social history, family history, and other medical information. The face sheet may be particularly useful in quickly reviewing stages of a medical encounter work flow, such as chief complaint stages and history of present illness stages, as well as the history of a patient's medical records in order to accelerate an examination of a patient.

In another exemplary embodiment, the disclosure is directed to a face sheet in a medical encounter system that includes finding elements that have a visual indication as to their history and have associated controls for canceling, reverting, or accepting the finding.

In a further exemplary embodiment, the disclosure is directed to an order entry interface that includes an organized set of orders and tests, organized under category headings. Each test category may further include fly-out menus and graphical display elements for selecting a test or order. The order interface further includes a set of requested orders that may be edited and changed. Moreover, in an encounter system, orders may be transferred from the physician's data entry interface to a nurse's interface or other interfaces associated with the encounter system, providing information useful for carrying out the tests and orders.

In another exemplary embodiment, the disclosure is directed to entry interfaces, such as order interfaces, that include keyword searching control elements and present search result information ordered by category. For example, the order entry interface may include a keyword search control that presents search results in a category-based listing.

In a further exemplary embodiment, the disclosure is directed to a summary or note interface that includes a listing of orders and coding associated with the orders and associated with billing. The coding associated with the orders or associated with the billing of the physician's examination may visually indicate whether the information collected during the exam is sufficient to justify the order or billing code based upon rules established by a third-party payer, such as an insurance company or a government agency, or rules established for the collection of data in, for example, a clinical study.

Generally, a medical encounter with a patient follows a workflow that includes stages, such as an ordered set of stages that includes chief complaint, history of present illness, medications and allergies, patient medical family and social history, physical examination, diagnosis, orders, prescriptions, and notes. Within any one encounter, some of the steps may be skipped. However, generally, the encounter follows the specified order of the workflow. In some encounters, information associated with the chief complaint, history of present illness, medications and allergies, and patient medical family and social history stages may be entered by a patient or other medical professional prior to a consultation with a physician. As a result, the interface system may provide a summary or face sheet to the physician including data and findings entered by the patient or other medical professional.

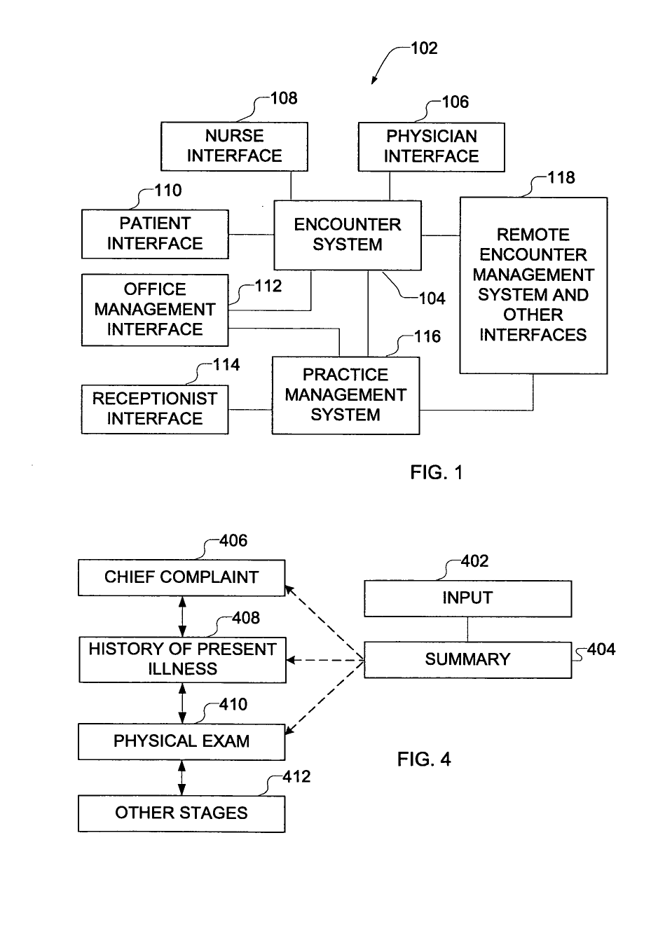

FIG. 1 includes an exemplary embodiment of an encounter management system. The management system 102 includes an encounter system 104, a physician interface 106, a nurse interface 108 and a patient interface 110. The management system 102 may also include a practice management system 116, an office management interface 112 and a receptionist interface 114. In addition, the management system 102 may include interfaces to remote encounter management systems and other remote computational systems 118.

In this particular embodiment, patient medical information is collected through specific interfaces, such as the physician interface 106, the nurse interface 108 and the patient interface 110. The information or patient medical data is stored in the encounter system 104, which provides the patient medical data to the interfaces 106, 108, and 110.

In one exemplary embodiment, the encounter system 104 provides XML or HTML documents to the interfaces 106, 108 and 110. The interfaces 106, 108, and 110 display the data and facilitate the collection of additional patient medical data. For example, the interfaces may be displayed in a browser that includes functionality to display and interact through formats such as HTML, XML, Java, Flash and various graphical formats.

The encounter system 104 may also be coupled to a practice management system 116. The practice management system may, for example, handle billing, appointment scheduling, and patient interactions. The encounter system 104 may provide data associated with patient medical encounters to the practice management system 116 for the generation of bills, related medical encoding, and tracking of billing. An office management interface 112, may connect to the encounter system 104 and the practice management system 116 permitting the management of each system 104 and 116 individually and management of the interaction between the encounter system 104 and the practice management system 116.

In addition, a receptionist interface 114 may be coupled to the practice management system 116. The receptionist interface 114 may be useful in scheduling appointments and managing patient contact information.

Further, the encounter system 104 and practice management system 116 may interact with remote systems, such as remote encounter management systems and other interfaces 118. A remote encounter management system 118 may, for example, store patient medical encounter data at a remote location for data redundancy, data mining and data management. For example, the data stored at a remote location may be used for mining disease and symptom relationships, determining epidemiological relationships, providing bio-terrorism and disease management information to government organizations, providing disease management data to insurance companies, and providing disease management and patient data to pharmaceutical studies. In addition, other interfaces 118 may include interfaces with laboratory systems and pharmacy systems.

In one exemplary embodiment, a patient schedules a doctor's visit through a practice management system 116, such as by contacting a receptionist who utilizes the receptionist interface 114. When the patient visits the physician, the patient is asked to enter medical data through the patient interface 110. For example, the patient may be asked a series of questions regarding the reasons for the current visit, insurances information and medical and social history data. This patient data is stored in the encounter system 104. Optionally, the patient may visit with a nurse prior to seeing the physician. The nurse may utilize nurse interface 108 to enter the patient medical information and augment or add to the patient medical data in the encounter system 104. When the physician visits the patient, the encounter system 104 may provide data to the physician interface 106. The physician, for example, may be provided with a summary or narrative of the data entered by the patient and the nurse through the patient interface 110 and nurse interface 108, respectively. In addition, through the physician interface 106, the physician may be provided with a set of options that link to interface screens associated with steps in a medical workflow.

A medical workflow may include stages. Each stage may be accessed in order. However, often a workflow may access the stages out of order, such as back tracking or skipping stages. The medical workflow stages may include chief complaint (CC), history of present illness (HPI), medication and allergies (Med/All), patient medical family and social history (PMFSH), physical exam (PE), results, diagnosis (DX), Orders, prescriptions (Rx), and notes. Often, a medical workflow proceeds through the stages in the order presented above. However, stages may be skipped as appropriate. In addition, a medical professional may backtrack through the workflow, as desired.

In another exemplary embodiment, a nurse may interact with a patient to collect medical data associated with stages with a medical workflow, such as the CC, HPI, Med/All, or PMFSH stages. The nurse may enter data, such as vital sign data, using a nurse interface 108. Through the physician interface 106, a physician may access the data, such as vital sign data, and perform subsequent stages in the medical workflow, such as PE, DX, and Orders stages. The orders and physician plans associated with the patient may be transferred via the encounter system 104 to the nurse interface 108. The nurse may perform tests or execute orders, such as taking blood or urine samples. Completion of the orders may be noted in the nurse interface 108. The encounter system 104 may provide a summary note to the nurse via the nurse interface 108, which may be electronically signed by the nurse.

In a further exemplary embodiment, the nurse interface 108 and the physician interface 106 may include a note system. The physician or nurse may enter a note into the physician interface 106 or nurse interface 108, respectively. The note may be provided to the designated party via the interfaces 106 or 108.

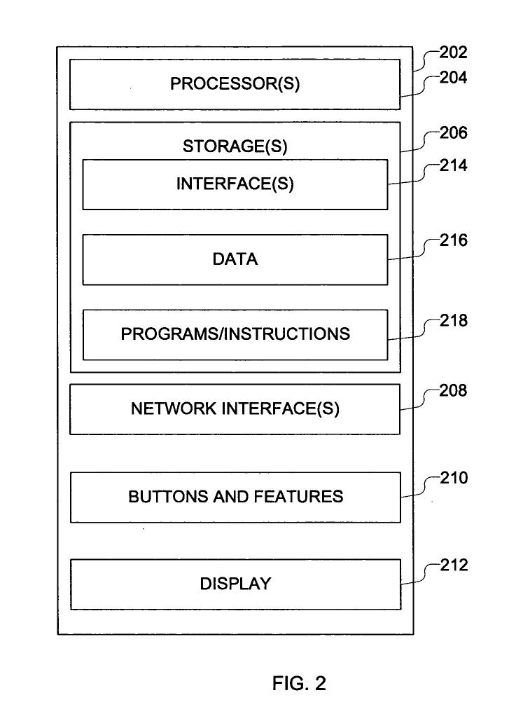

FIG. 2 depicts an exemplary embodiment of an interface device 202. The interface device 202 includes processor(s) 204, storage(s) 206, network interface(s) 208, buttons and features 210, and a display 212. The storage or storages 206 include information for creating interfaces 214, additional data 216, and programs and instructions 218. Exemplary embodiments of an interface device include computation devices, handheld circuitries, desktop computers, touch screen kiosks, notebook computers, computer pads and ultra portable computers. In one particular embodiment, the interface device 202 is a wireless pad device with a touch screen display.

The interface device 202 may, for example, interact with encounter system via the network interface(s) 208. For example, the network interfaces 208 may include wired and wireless interfaces. In exemplary embodiments, the wireless interface may include an IEEE 802.11 compliant interface or a Bluetooth® compliant interface. Data transferred through the network interfaces 208 may be stored in storage 206. The data may include interface data 214, such as HTML and XML documents and graphics data, and other data 216. The processor(s) 204 may interpret programs and instructions 218 to provide interfaces utilizing interface data 214 and other data 216. The programs and instructions 218 may, for example, include browsers, interpreters, virtual machines, and executables.

The interface may, for example, be provided via the display 212, having interaction provided through buttons and features 210. In one exemplary embodiment, the display 212 and features 210 are included in a touch screen display. Buttons and features 210 may further include a shading button, power buttons, buttons for manipulating the appearance of the display, and volume controls.

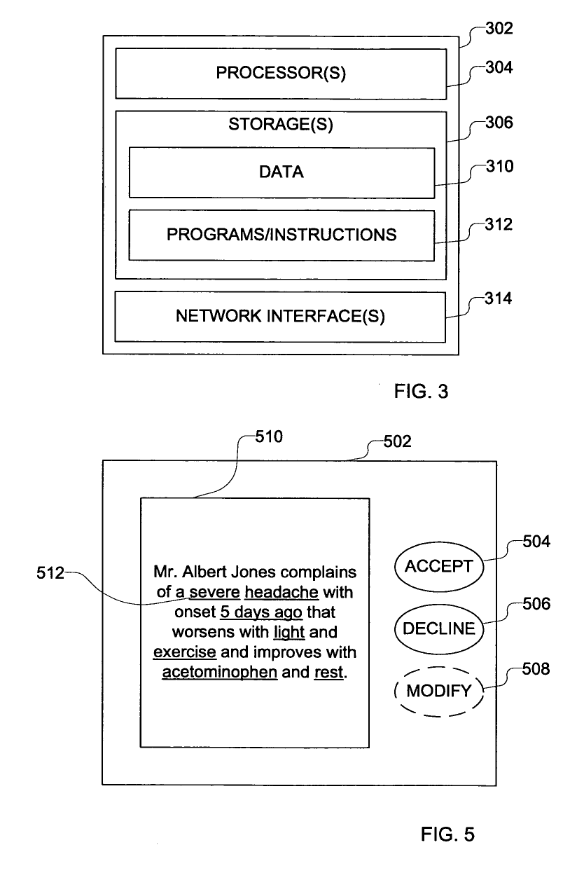

FIG. 3 illustrates an exemplary embodiment of an encounter system 302. The encounter system 302 includes processor(s) 304, storage(s) 306 and network interface(s) 314. In one particular embodiment, the encounter system 302 may also include a display and interface devices, such as a keyboard and mouse.

The encounter system 302 may interact with interfaces via the network interface or interfaces 314. Data exchanged via the network interfaces may be stored in the storage or storages 306, such as in data 310.

The storage or storages 306 may include data 310 and programs and instructions 312. The data 310 may, for example, include a database of encounter data, such as findings data. Findings data may include newly entered medical findings and medical findings from past encounters. The data 310 may also include graphic elements, interface data files, such as HTML files, and multimedia files, such as scripts and Flash files. An exemplary encounter system is also described in U.S. patent application Ser. No. 10/725,948, entitled “Data Structures for Context Based Rule Application.”

The processor(s) 304 may interpret programs and instructions 312 to provide interfaces through the network interfaces 314. For example, the processor(s) 304 may operate based on programs and instructions 312 to produce HTML documents and other interface elements. These interfaces may utilize data 310. Exemplary embodiments of the interface data include data formatted in formats such as XML, HTML, and other document formats.

In one particular example, data acquired from one or more interfaces during a patient encounter may be used to provide a summary or narrative to subsequent decision makers along with links to optional stages within a medical workflow.

FIG. 4 depicts an exemplary medical workflow in which an input 402 is received. The input 402 may, for example, be provided by a patient, nurse, or combination of both. An encounter system develops a summary and interface that includes links to interfaces associated with stages within the medical workflow. For example, the encounter system may provide a summary interface 404 with links into stages within a physician workflow, such as the chief complaint stage 406, the history of present illness stage 408, or physical exam stage 410. In other embodiments, the summary interface 404 may provide options to enter other stages 412 of a physician workflow, such as an orders stage, diagnosis stage, prescription stage, and notes stage.

For example, a patient may enter discrete inputs, such as inputs associated with a chief complaint. In addition, a nurse may enter additional discrete inputs, such as data associated with a history of present illness or vital sign data, such as temperature, blood pressure, weight and height. In one exemplary embodiment, the discrete inputs are data associated with items in a patient input screen. The discrete inputs, such as those entered by the patient, may be temporarily stored, awaiting approval by a physician. The physician may accept the discrete inputs, modify the inputs, or reject the discrete inputs and enter a new set of discrete inputs.

In one particular embodiment, the summary 404 may provide a narrative with an accept or decline button. FIG. 5 depicts an exemplary summary interface 502 that includes a narrative 510 and a set of options 504, 506 and 508. In this particular example, a narrative 510 is provided to a physician with options to accept the narrative 504, decline the narrative 506 or modify the narrative 508. When a physician accepts the narrative by activating accept link 504, the physician may be provide with an interface associated with proceeding to a physical exam stage during the patient encounter. When the physician activates the decline link 506, the physician is directed to an interface to a stage that is earlier in the medical workflow, such as the chief complaint stage. In this example, the physician may replace patient data associated with the earlier stage in the medical workflow. If a modified option is provided, such as link 508, selection of that link 508 may lead to an intermediate interface associated with a stage, such as the history of present illness stage 408.

The exemplary embodiment illustrated in FIG. 5 shows a narrative presentation of the summary 510. Discrete inputs entered by a patient or nurse may be processed through a text generation engine to provide a narrative for display. In one particular embodiment, the narrative 510 includes underlined terms, such as severity 512. These terms may be edited by selection of the underlined term. For example, a fly-out may present options for editing severity of a headache or pain.

An alternative summary may be provided as discrete findings. For example, the findings data may be presented as follows:
Patient: Mr. Albert Jones
Chief Complaint: headache
Severity: severe
Onset: 5 days ago
Worsens: light, exercise
Improves: rest, acetaminophen
   In this example, underlined terms may be selected for editing. In addition, accept, modify and decline options may be provided.

In a further alternative summary, the findings may be presented as editable findings, including, for example, radio buttons associated with a list of options, text entry boxes, or check boxes associated with a list of options. For example, severity may be presented with a set of radio buttons labeled mild, moderate, and severe, wherein the sever radio button is selected. Onset may be associated with a text box for entering a numerical value and a drop-down menu for selecting a time unit, such as minute, hour, day, week, or months. A worsens field may be presented with a list of activities or other items that worsen a conditions. The worsen filed may be presented with a set of checkboxes labeled light, exercise, noise and fatigue with the light and exercise checkboxes checked. Similarly, an improves field may be presented with a set of checkboxes labeled rest, acetaminophen, aspirin, and other medications, with rest and acetaminophen checked. In other embodiments, the discrete or editable findings may include accept/modify/decline options associated with individual findings. Other embodiments may use other graphical methods such as highlighting instead of underline to indicate editable findings.

In a particular embodiment, the interface includes a narrative and at least two links to interfaces associated with stages within a physician medical workflow. Accepting the narrative may link to a later stage in the physician workflow while declining the narrative may lead to an earlier stage in the physician workflow.

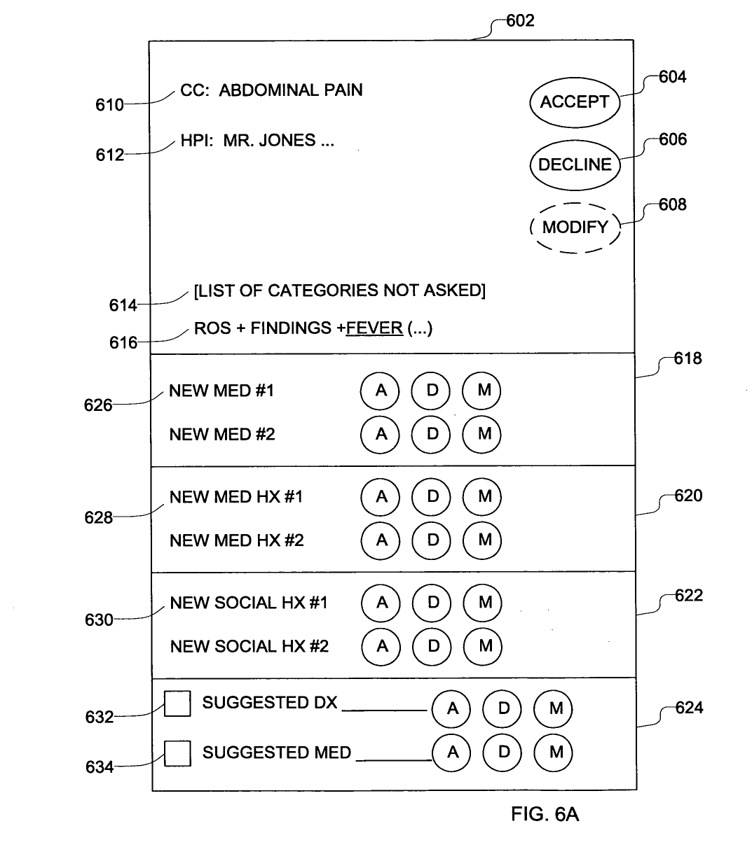

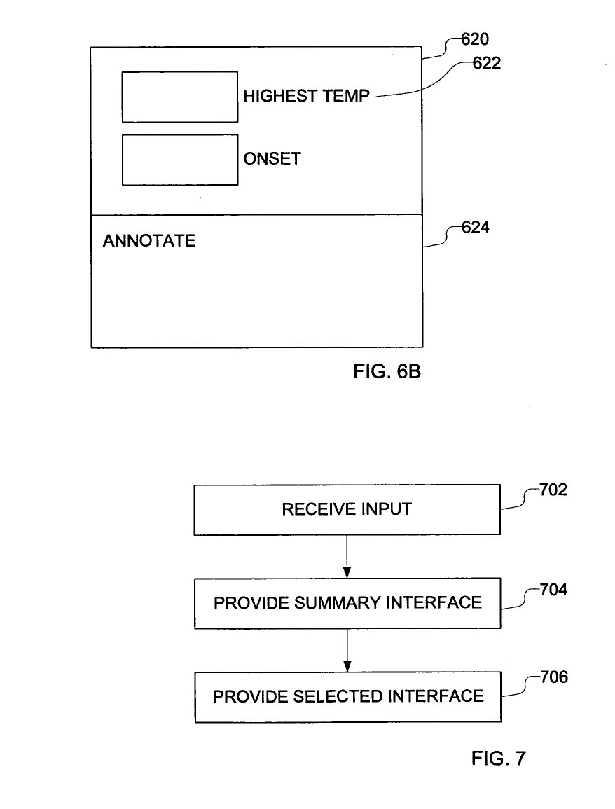

FIG. 6A depicts another embodiment 602 of a summary interface. The summary interface 602 may, for example, include narrative information associated with previously completed stages within the medical workflow, such as a chief complaint narrative 610 or a history of present illness narrative 612. In addition, the narrative may include patient medical history information. Data provided in these narratives (610 and 612) may, for example, be collected through other interfaces such as patient interfaces or nurse interfaces.

The interface 602 may also include two links to stages within a medical workflow, such as an accept link 604 and a decline link 606. The interface may optionally include a third link, such as a modify link 608. If, for example, a physician accepts the narratives, the link might lead to a subsequent step in the medical workflow. However, when the physician declines or disagrees with the narratives, the physician may be directed to an earlier stage in the medical workflow, such as the chief complaint stage. The physician may be provided with interfaces to replace or modify patient data. Alternatively, when the physician selects a modified link, the physician may be directed to an intermediate stage in the physician workflow, such as the history of present illness stage. In another embodiment, a modified link might lead to a condensed version of the chief complaint or history of present illness interfaces. In an alternative embodiment, accept and decline links may be associated with each stage narrative, such as narratives 610 and 612. In an alternate embodiment, accept/modify/decline links may be associated with an individual finding element or a group of finding elements.

The interface 602 may further include a list of categories not answered or not asked, such as list 614. In one particular embodiment, the list 614 may seek information associated with the etiology of a complaint and may link to a fly-out summary. The interface may, for example, provide links to fly outs for subsequent stages within a medical workflow or for seeking additional information associated with previous stages. In one exemplary embodiment, links may be provided, such as links 616 that include a request for additional information or provide for a truncated physical exam. Selecting an item within the list of additional information such as fever, might lead to a fly out including interface elements for providing additional data. One exemplary embodiment is provided in FIG. 6B. Fly out 620 might include interface elements 622, such as entering a highest temperature of a fever and a time and date of onset. In addition, the interface fly out 620 may be provided with an annotate space 624, and may include or provide the ability to for a physical user to annotate additional information.

Returning to FIG. 6A, optional sections of interface 602 may include new medicines section 618, new medical history section 620, new social history section 622, and artificial intelligence section 624. For example, if during a patient interview through the patient interface or the nurse interface, a patient discloses a new medication prescription, a new medical history item, or additional social history information, these items may be provided to the physician for review. For example, the physician may be provided with a new medicines interface 618 that includes a new medicine #1 entry 626. This entry may include an acknowledgement element such as a button, checkbox, or radio button. For example, the entry may include buttons such as accept, decline or modify. When the physician accepts the new medicine, the medical data associated with the patient may be modified. When the physician declines the entry 626, the patient medical data may be altered or canceled, and, when the physician activates a modify link, the physician may be directed to a new interface that enables entry of additional information or modification of the existing information associated with the medicine entry 626.

Similarly, if new medical history is disclosed, the medical history interface section 620 may provide a new medical history #1 item 628. This item may also include an acknowledgement element, such as accept, decline or modify buttons. By accepting the medical history the physician acknowledges the existence of the medical history and the data is stored with the patient medical data. Declining removes that data from the patient medical data, and modifying leads to an additional entry screen allowing modification of the information. Similarly, a social history item 630, may include acknowledgement elements, such as accept, decline or modify buttons in the optional interface section 622.

In one exemplary embodiment, a patient provides, via a patient interface or through conversation with a nurse, information about new medications that the patent is taking, information about new medical conditions that have arisen since previous visits or information about changes in social history. This information is stored in an encounter system. When present in the encounter system, this information may optionally be provided to the physician so that the physician will have an opportunity to acknowledge its existence or modify its content.

Interface 602 may also include a likely action section 624. The likely action section 624 provides options to select findings not entered by a nurse of patient or to issue orders. In one embodiment, the other options include suggested diagnoses 632 and suggested plans or orders 634. The items may, for example, include acknowledgement elements, such as a radio button, a check box or accept, decline, or modify buttons. The accept, decline or modify buttons allow a physician to accept, decline or modify the likely action suggestions. In one exemplary embodiment, the system may present a completed narrative in response to accepting a diagnosis and generate a billing code. In another exemplary embodiment, the system may automatically generate a completed order form or plan form in response to accepting the suggested plan or order. The suggested plan or order may include therapies, medical procedures, and laboratory tests. Therapies may include treatments and prescriptions. For example, a populated prescription form may be presented to the physician in response to accepting a suggested medication.

In addition, the interface 602 may display malpractice warnings. For example, a malpractice insurance company may request that a message be displayed to physicians working on a tendon in the foot because such injuries are a frequent source of malpractice claims. The interface 602 may display the malpractice warning at the top of the interface or in the artificial intelligence section 624. Furthermore, the interface 602 may request information that would complete the parameters for billing a specific code. Such a request may be presented in the links 616 or in the artificial intelligence section 624.

In one embodiment, the options included in the likely action section 624 are based on rules that take findings from current or past encounters or both as input and provide suggested action items as output. For example, the output may include a malpractice warning when finding associated with a particular condition, such as tendons of the foot, are entered. Other exemplary outputs may include suggested prescriptions, suggested diagnoses, warnings and alerts, suggested tests and orders, and suggested questions or lines of query.

In another embodiment, the discrete inputs, both those newly entered and those from past encounters, may be used as inputs into artificial intelligence systems, such as expert systems, decision trees, and neural networks, to produce suggested actions, such as suggested prescriptions and diagnoses.

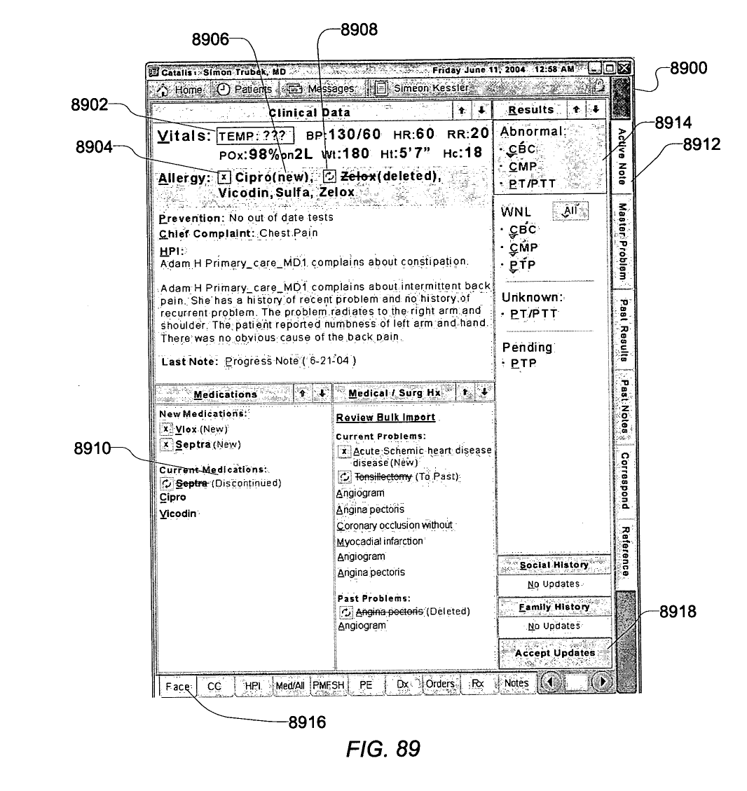

FIG.89 includes an illustration of an exemplary summary or face sheet 8900. In one exemplary embodiment, the face sheet is presented to a medical professional, such as a physician, at the beginning of a medical consultation. Each of the encounter workflow steps may be accessible from the face sheet through a tab interface, such as interface 8916. In addition to the interface provided for the present encounter, master problem, past results, past notes, correspondence and references interfaces may be accessible from a tabbed interface 8912.

In this particular embodiment, the face sheet 8900 includes vitals information, allergy information, chief complaint, history of present illness information, a narrative, information about the last progress note, and information regarding medications, medical and surgical histories, social histories, family histories, and past order results. For example, a clinical data section may include vitals information, allergy information, the chief complaint, and history of present illness information, as well as a medical narrative. This data may be collected prior to the physicians visit, such as through queries at a patient interface or data entered via a nurse interface. Alternatively, the data may be entered by the physician by accessing tabs, such as the chief complaint, history of present illness, medical and allergy histories, and patient medical, family and social history sections 8916.

In one particular embodiment, clinical data, such as vitals data, that is missing or out of the ordinary may be highlighted or color-coded to indicate abnormality or absence. Vitals data may include temperature, blood pressure, heart rate, respiratory rate, blood oxygenation, height, weight, and HC. For example, when temperature is abnormal or has not been taken during a previous step, the temperature indication element 8902 may be highlighted to indicate its abnormality or the absence of data. For example, if a temperature were high, the element may be highlighted in red to indicate the abnormality. In another exemplary embodiment, if temperature is desired to justify an order or a task, the temperature element may be highlighted to indicate its absence so that the physician knows to enter the data in support of orders, diagnoses, and prescriptions that may be later entered.

The face sheet and other sheets within the medical data encounter interfaces may include elements that visually indicate their history. For example, a patient may indicate a new allergy to a drug, such as Cipro. The new entry may show up on an interface, such as the face sheet 8900, including a visual indication 8906, such as the word “new,” indicating a new data entry and including a control element 8904 that allows a physician to delete the entry. Alternatively, visual indications may include indications of new entries, deleted entries, or indications where there has been a history of changes, such as the word “multiple.” In the case of drugs and medication, the visual indicator may also indicate the discontinuing of a particular medication, such as indicator 8910.

For example, when a physician is on vacation or when another physician is on-call in place of the primary physician, changes may be made to a patient chart. In another exemplary embodiment, a patient may enter a particular set of information, a nurse may alter that information, a visiting physician may further alter the information, and the primary physician, when reviewing the entered data may want to review the history in order to ascertain which entry is correct. Such situations arise when more than one nurse or physician's assistant interviews a patient in preparation for the physician's visit. In addition, such situations occur when physicians are on vacation or when a patient requests emergency service when the physician is absent or unavailable. Generally, knowledge of the history of the changes aid the physician in determining the proper final state of the item, such as for an allergy or a medical history. Errors in drug allergies and medical histories may lead to incorrect diagnosis or writing prescriptions that are dangerous to the patient and yield high-probability of malpractice suits. As such, an element that carries with it visual clues of its entry history, would be especially advantageous to physicians.

The entered element may also include a control element, such as control element 8904, that permits deletion, reversion, or acceptance of the new entry. In one exemplary embodiment, the control element may permit deletion of the entry, as indicated by control element 8904. In another example, the control element may permit the physician to revert back to a previous value, such as control element 8908. While the visual indicators and control elements are described in relation to a drug allergy, the control elements and visual clues may be used to indicate medications, medical and surgical history, past problems, social and family history and other data collected for use in medical decisions.

The face sheet may also include an indication of test results that were requested as a result of the examination or were requested in the past. In particular, the test results may be listed in an order by name or by result. For example, abnormal results 8914 may be placed preferentially near the top of a list to encourage review by a physician. Furthermore, these results may be highlighted or colored and/or labeled to further indicate their state as abnormal. Normal results and pending tests may be subsequently displayed under different labels and with different colorations and indications.

The face sheet 8900 may further include buttons that allow physicians to accept all of the updates to the face sheet, such as button 8918. Once the updates have been entered and accepted, interfaces for subsequent steps in a medical encounter workflow, such as the physical examination step, diagnosis step, order step, or prescription step, may be provided. In alternative embodiments, accepting the update may update the face sheet 8900 and the physician may proceed to further steps in the medical encounter workflow by selecting a tab from the tabs 8916 or a tab from the tabs 8912. In a further exemplary embodiment, the face sheet 8900 may include artificial intelligence suggestions, such as suggested diagnosis, common prescriptions prescribed for similar cases, or common orders issued by the physician.

In practice, the system may utilize the method illustrated in FIG. 7. Generally, the encounter system receives an input, as shown in step 702, such as input via a patient interface or a nurse interface. This information may be associated with stages within a medical workflow, such as the chief complaint or history of present illness stages. This information is summarized and a summary interface provided, as shown at step 704. The summary interface may, for example, include summaries and narratives associated with stages within the medical workflow and at least two options that link to stages within the medical workflow. Once a selection of the two options is made, the encounter system may provide the selected interface, as shown at step 706. For example, a physician may receive a summary of a chief complaint or history of present illness and accept these summaries. In response, the encounter system may provide a physical exam interface. Alternatively, the physician may decline summaries provided and may be provided with a chief complaint or history of present illness interface.

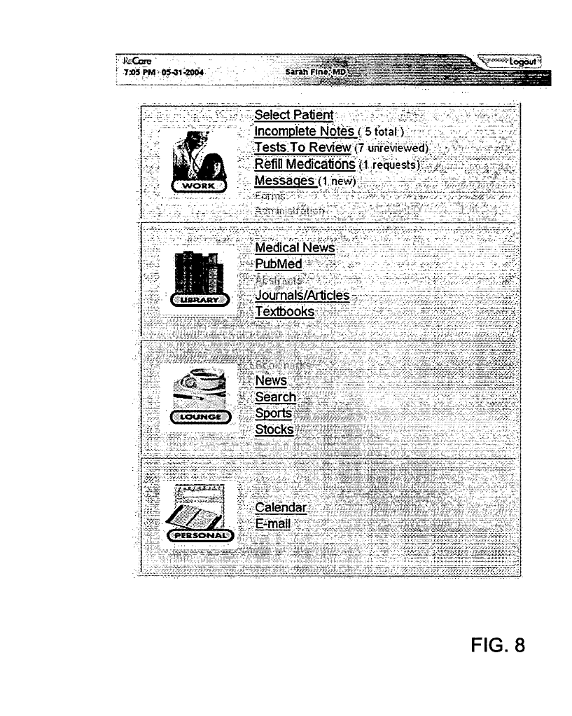

FIGS. 8-24 depict an exemplary physician interface. FIG. 8 depicts an exemplary entry page that includes a work area, library, lounge and personal area. The work area may, for example, include a select patient link, incomplete note links, tests to review link, refill medications link, messages link, forms links and administration links. The library area may, for example, include links to medical news, medical publications, abstracts, journals and articles and textbooks. The lounge area may, for example, include bookmarks, links to news, search engines, sports information, and stock information. In addition, a personal area may include a calendar and access to email.

In the work area, selecting the select patient link may lead to a listing of patients that will allow a physician to select a patient and enter medical data associated with the patient. The incomplete notes link may include an annotation of the number of incomplete notes. When selected, the incomplete notes link may lead to a note-taking interface. Similarly, the tests to review link may include an annotation of the number of tests for review. When selected, the tests to review link may lead to an interface for selecting a test and reviewing summaries of test results.

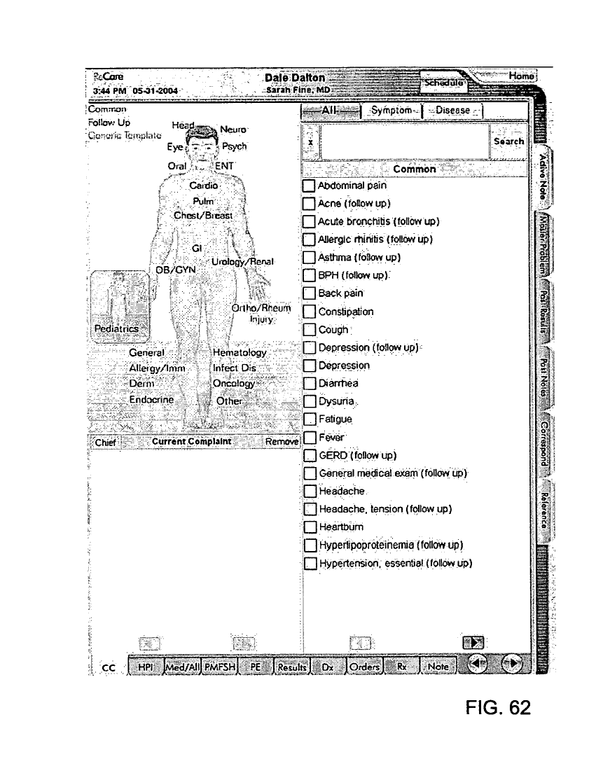

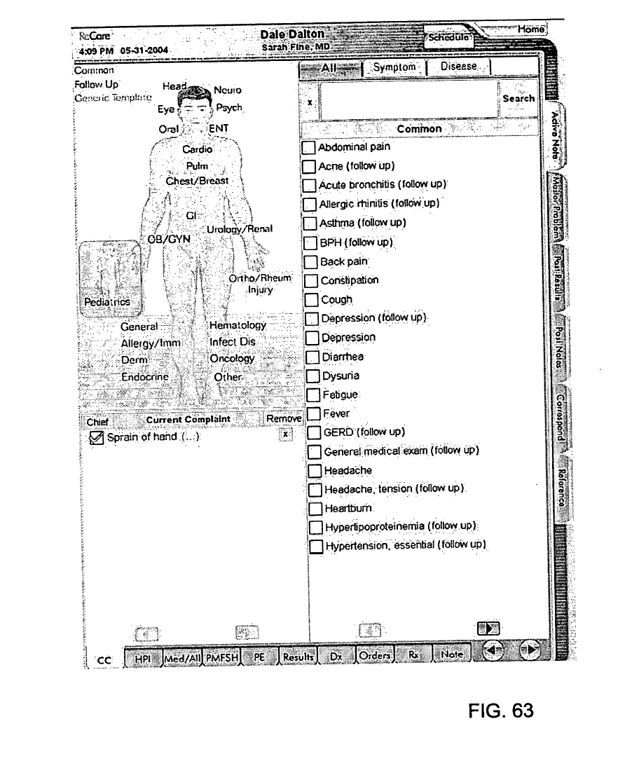

After selecting a patient, the physician is provided with interfaces associated with stages in a medical workflow. In one particular embodiment, a physician will be direct through a series of workflow stages. The first stage may, for example, be the chief complaint stage as depicted in FIGS. 62 and 63. In the exemplary interface depicted in FIG. 62, the physician or healthcare provider is provided with a graphical method of selecting a chief complaint, such as through selection of anatomical parts. Additional graphics may permit switching between an adult anatomy and a pediatric anatomy. Further, the interface may provide elements for a text based search. In one particular embodiment, the physician may select a tab from the tabs marked “All”, “Symptom”, and “Disease.” The physician may enter a text string, such as the first few letters of a desired term. For example, the physician may use a handwriting interface to enter the search string and hit the search button. A reduced set of elements matching the search string may be displayed below the search. In another embodiment, the physician may search alphabetically through the list of items or an initial list of items that are commonly selected may be displayed. Once a complaint is selected, it may be displayed, such as below the anatomical graphic, as illustrated in FIG. 63.

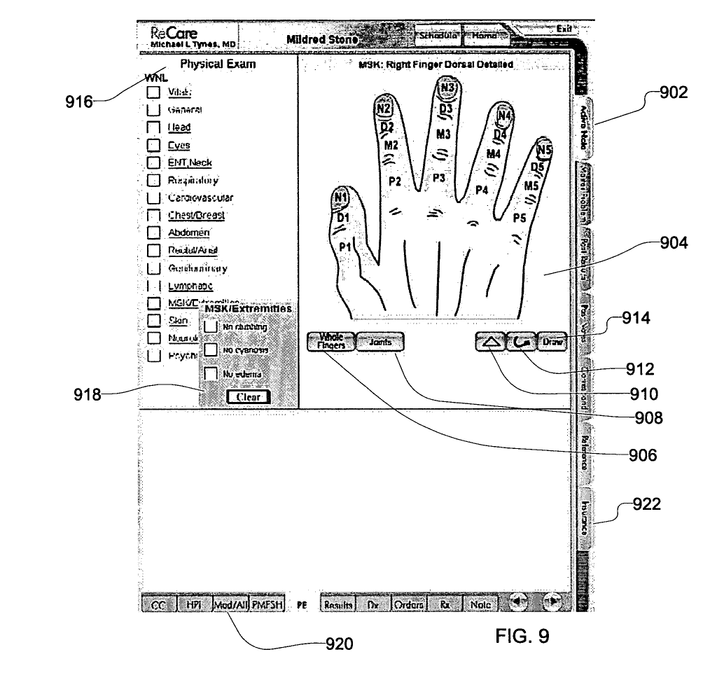

A first interface may include a narrative associated with previously entered information and links to at least two stages in the medical workflow. When the physician accepts the narratives, an interface may be provided for a subsequent stage in the workflow such as a physical examination (PE) stage. One exemplary interface for the PE stage is depicted in FIG. 9. In this exemplary embodiment, a physical exam of the hand is being performed. The interface 902 provides an image of a hand 904. Underneath the image of the hand 904, additional buttons are provided such as a selection button for viewing of a whole finger view 906, a selection button for viewing joints 908, a selection button for viewing a different hand 910, and a selection button for viewing the opposite side of the hand 912. In addition, a button 914 is provided to allow annotating or drawing on the image of the hand 904. For example, a physician may draw the location and size of a cut located on the hand.

In another area of the screen, other physical exam options may be provided, such as in area 916. Example area 916 provides links to information associated with vitals, the head, the eyes, the cardiovascular system, and other systems. When a particular system is selected, an additional fly out may be provided, such as fly out 918. In this exemplary embodiment, a muscular/skeletal fly out is provided with options such as no clubbing, no cyanosis, and no edemas. In addition, selection of links within area 916 may change the image 904. Selection of areas within the area 904 may link to subsequent images, such as a hierarchy of images leading from an image of the body to an image of a body part or system. For example, the MSK/Extremities link may show a whole body image with the option of viewing the front or back of the body. The image may include links to views of arms that link to images of hands that link to images of fingers.

In other locations around the interface 902, additional buttons or tabs may be provided to link to other stages within a medical workflow, such as tabs 920, or other sets of patient information, such as tabs 922. For example, a physician may select the HPI tab and enter data associated with the history of present illness stage of a medical workflow. Alternatively, the physician may, for example, review master problems, past results, past notes, correspondences, references, or insurance information through tabs 922.

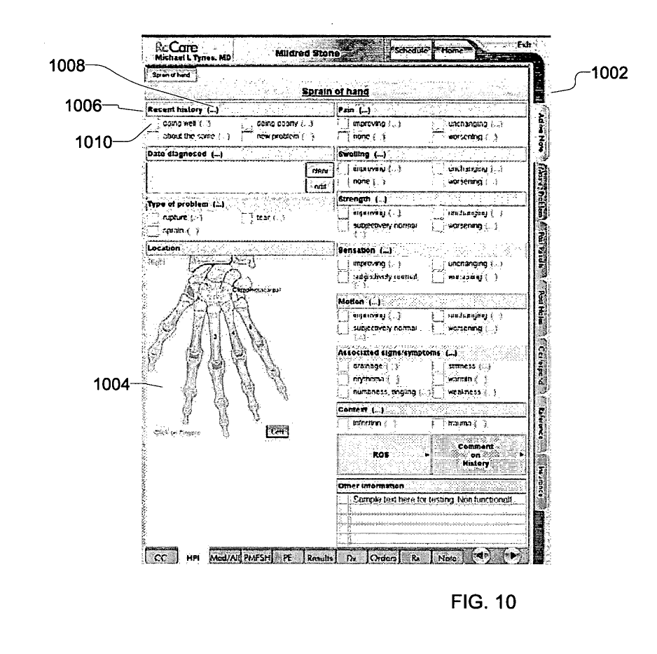

FIG. 10 depicts an exemplary embodiment of a history of present illness interface associated with a sprain of a hand. The interface 1002 may include an image of a hand 1004. In addition, the interface 1002 may include categories associated with the sprain of the hand, and sub items underneath those categories. For example, one category may be a recent history category 1006. The recent history category 1006 includes, for example, four items, such as the “doing well” item 1010. Each item may include a data entry element such as a check box or a radio button. Selection of items and annotation of categories act as discrete inputs. Each item is associated with specific findings. These findings may be used to aid in navigation to areas within the medical workflow or may be used to augment the generation of subsequent interfaces. For example, the data entered in the chief complaint stage, such as indication of a sprain of hand, may lead to a history of present illness interface specific to sprain of hand. Data entered into the history of present illness interface augments the appearance or elements of a subsequent stage, such as the physical exam stage interface. Similarly, data entered in a patient interface or nurse interface may augment later stage interfaces.

In addition, the category heading and/or item heading may include an indication that links to an annotation screen, such as an ellipsis 1008. Alternatively, the annotation link may include a graphic element, such as a pen image, a plus sign, an arrow, or a back slash surrounded by parenthesis. The appearance of the annotation link may change once an annotation has been entered. For example, the annotation link may be bolded once an annotation has been entered.

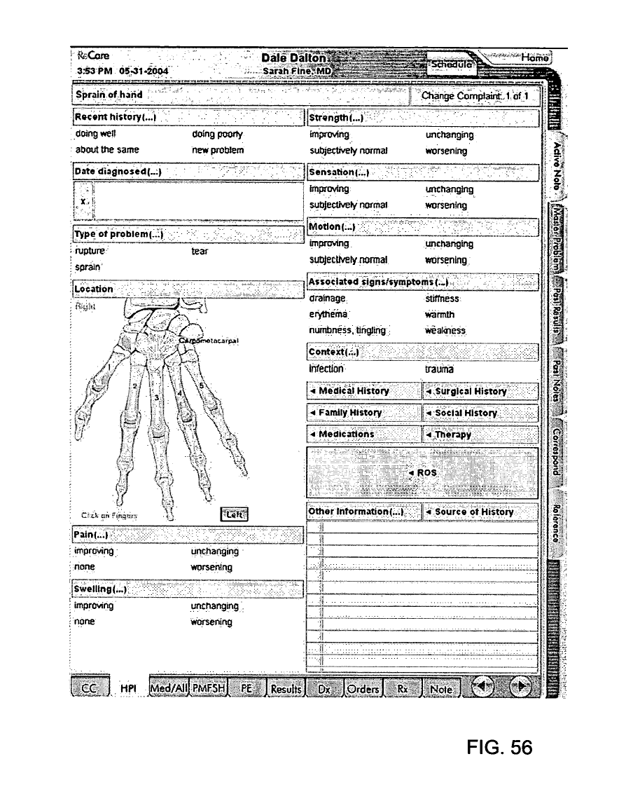

An alternative embodiment of an HPI interface is depicted in FIG. 56. In this embodiment, the checkboxes are replaced with graphic indications that appear under the text labels associated with the findings. Each category includes a selectable item for entering an annotation. However, the items within each category display the selectable item for entering annotations when selected or, for a tri-state element, given a negative indication.

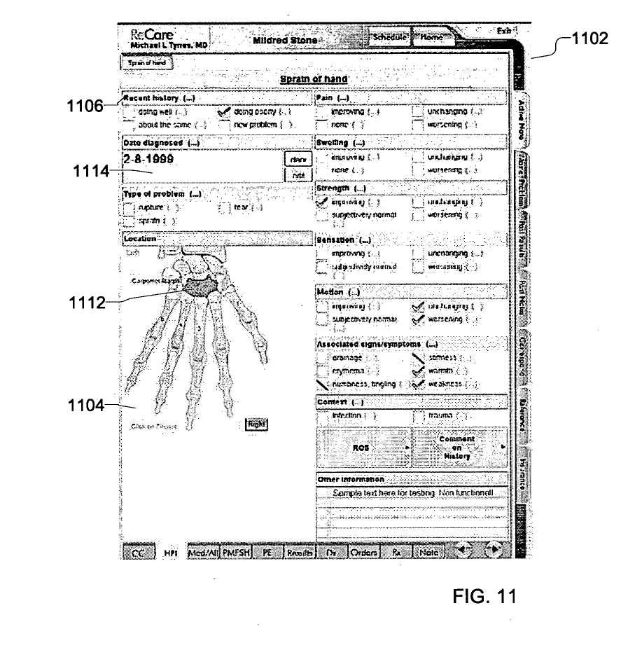

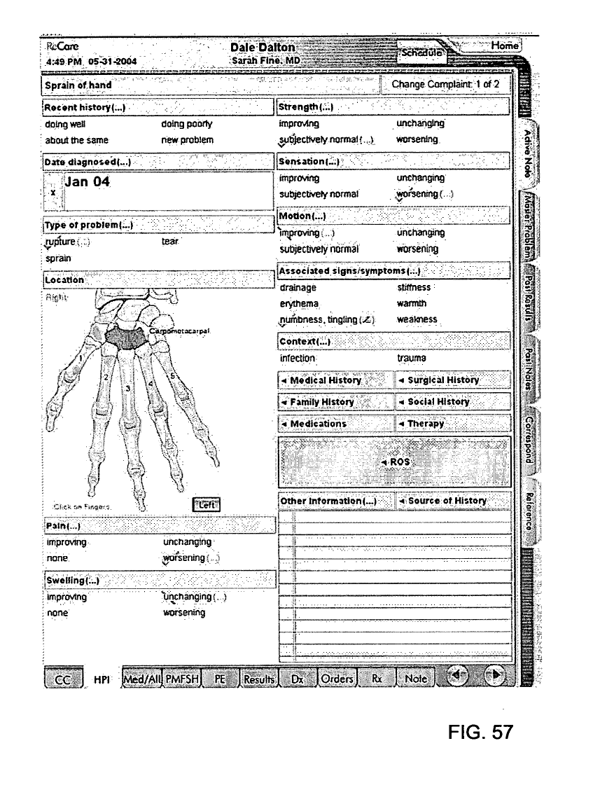

FIG. 11 depicts the exemplary sprain of hand history of present illness interface 1102 with data entered. The data entry interface 1102 depicts a selection of a location 1112 within the image of the hand 1104. In addition, categories, such as recent history category 1106, include checked items, such as the “doing poorly” item under the recent history category 1106. The interface 1102 may include character recognition regions, such as region 1114, that permit the hand written entry of data that may be subsequently converted to text. In addition, annotations may appear in another information area. FIG. 57 depicts an alternative embodiment.

Items under the categories may be tri-state elements and, as such, may be checked, crossed out, or not entered. Checking an item may, for example, indicate that the item is indicated or found. Crossing of the item may, for example, indicate a negative association or a lack of finding.

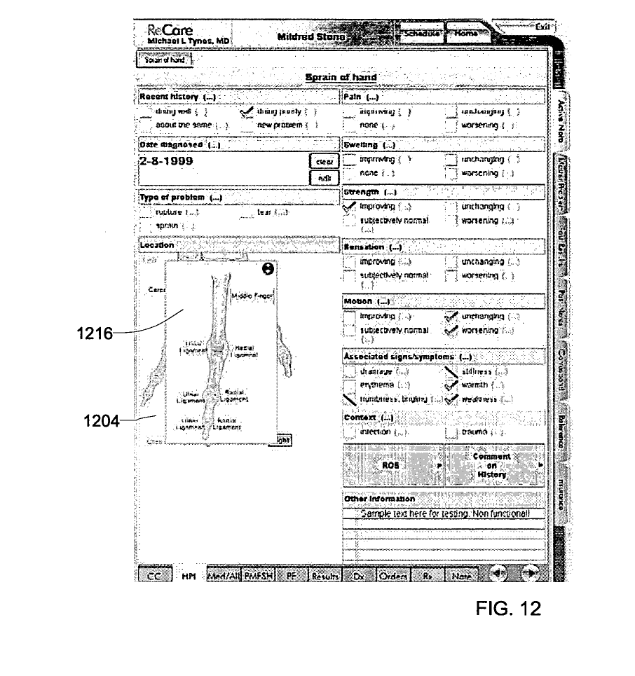

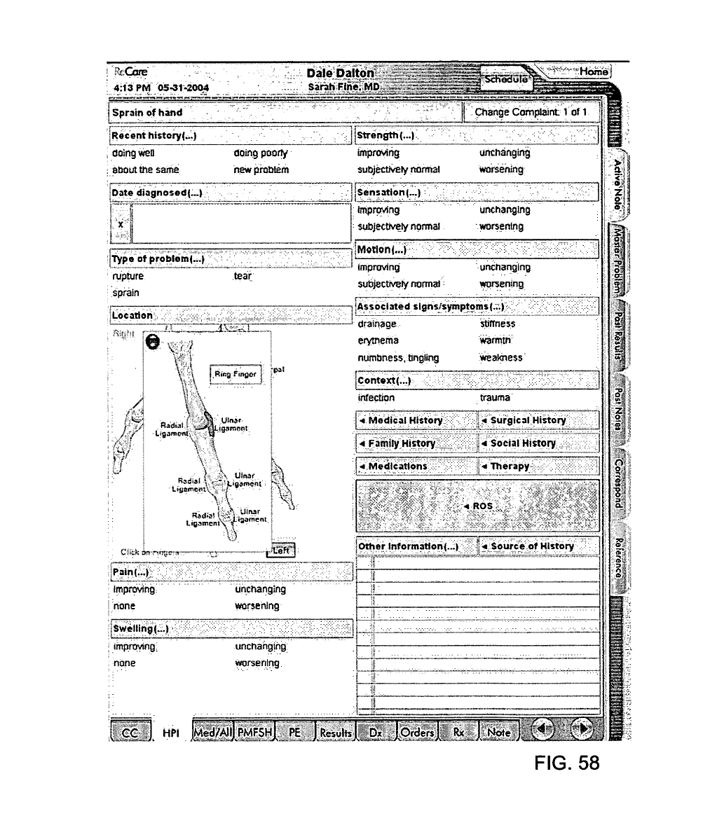

FIG. 12 depicts a further interface showing the image hierarchy associated with, for example, an image of a hand. Fly outs, such as fly out 1216, associated with features within a given corporal location, such as the hand image 1204, may be provided. Such an image hierarchy may enable a physician to provide further detail about the location of an injury. In one exemplary embodiment, the images are implemented as multimedia elements, such as Flash elements. In the particular embodiment depicted in FIGS. 10, 11, and 12, the selection of a portion of the center of the hand may highlight that region. Alternatively, selection of a finger may provide a fly out of the finger, such as fly out 1216. Selection within an image may include a single click or a double click. In an alternative embodiment, a single click may highlight a portion of an image and a double click may result in a fly out for parts having associated fly outs. In general, the interface includes a hierarchy of images that are linked, at least in part, based on anatomy. An alternative embodiment is depicted in FIG. 58.

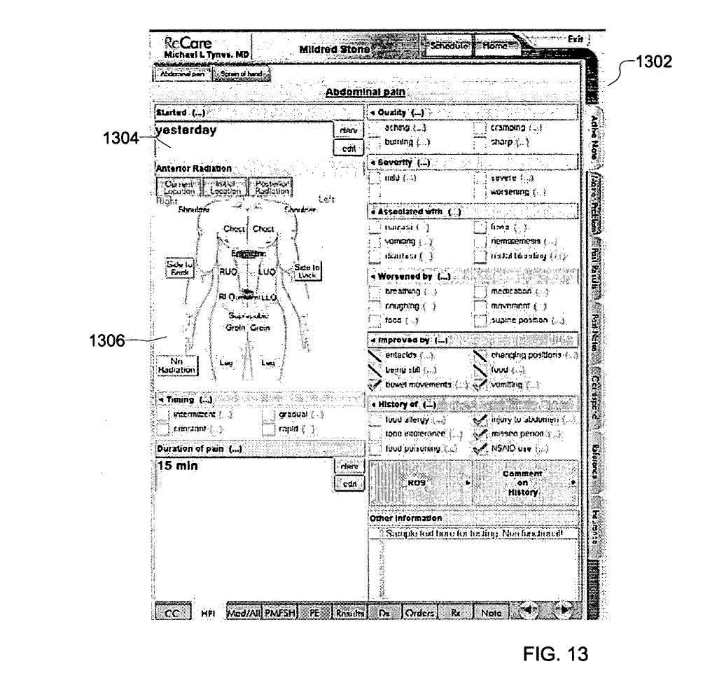

FIG. 13 depicts another embodiment of a history of present illness interface, such as an interface associated with an abdominal pain chief complaint. The interface 1302 includes a different layout and has similar elements such as a handwriting recognition area 1304, an image area 1306 and categories with subcategories.

In one particular embodiment, the encounter system provides the interface data including layout, graphic elements, and states of items (i.e. checked, slashed, or empty). The interface data may depend on data provided through the chief complaint interface.

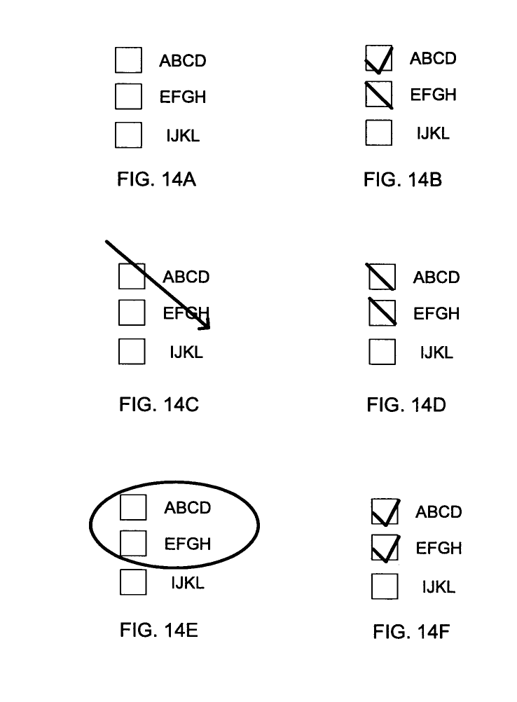

Selection of or changing status of items in the categories may be accomplished through a gesture interface. FIGS. 14A-14F depict exemplary methods for entering data into the items under categories using a gesture, such as with a stylus or pen and a touch screen display. For example, the interface may provide a gesture interface that allows for group selection or de-selection of items. FIG. 14A depicts a set of unselected items. FIG. 14B depicts individual item-by-item selection. For example, a physician may check an item by touching it once, cross through an item by touching the checkbox twice, or leave the item blank or unselected by not touching the checkbox at all or by touching the checkbox three the times. In an alternate embodiment, a physician may cross through multiple items by gesturing through the items as shown in FIG. 14C. This gesture results in the crossing out of items through which the cross was made, as shown in FIG. 14D. Alternatively, multiple items may be checked using a gesture, such as the circular gesture shown in FIG. 14E. The circular gesture might result in the checking or the selection of multiple boxes as depicted in FIG. 14F. While these gesture controls have been discussed relative to checkboxes, they may be applied to other selectable graphic types.

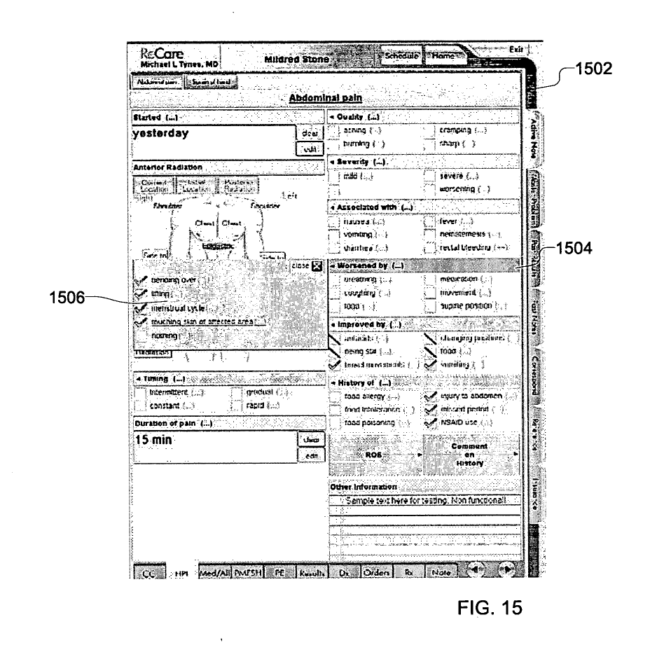

Each category within an interface may present a reduced list of items, such as those most commonly selected. FIG. 15 depicts an exemplary interface 1502 in which a category 1504 includes a limited set of six commonly selected items. Selection of the category, such as the “worsened by” category 1504 may result in a fly out 1506 that includes additional options. For example, a user may click on an arrow next to the label or category, hold a mouse or pen over the category for a period of time, or select the category by one or multiple clicks. The additional options provided in fly out 1506 may, for example, be selected using gestures or by clicking the entry box. In addition, each of the items in the fly out may be provided with a link to an annotate interface.

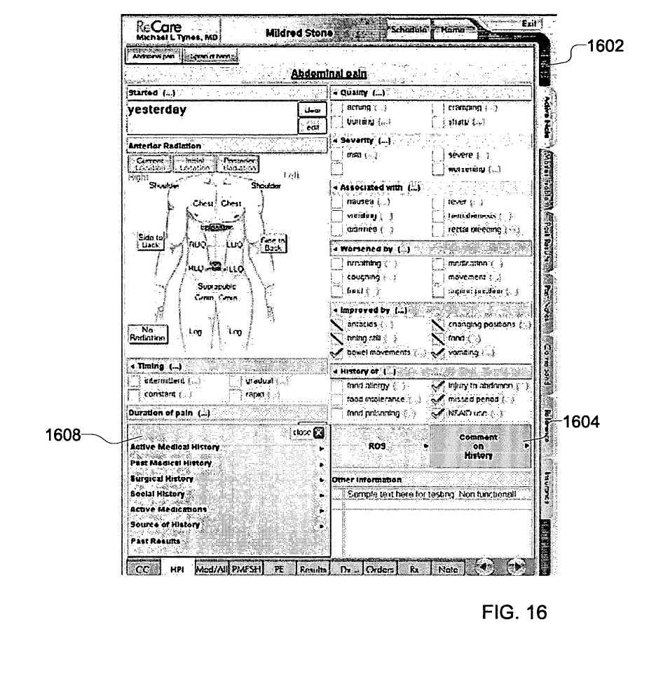

In some categories, such as category 1604 depicted in FIG. 16, a large number of choices may be available. As a result, a fly out 1608 may be provided that links to subsequent interfaces or additional fly outs as indicated by an arrow located or associated with each item.

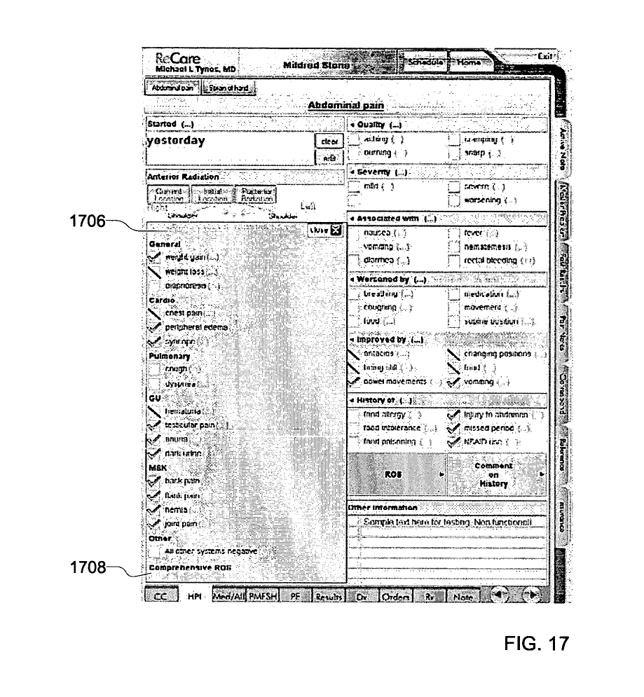

FIG. 17 depicts an alternative example in which a review of systems screen or fly out 1706 includes a reduced set of review of system items with an additional link 1708 to a more comprehensive review of systems interface.

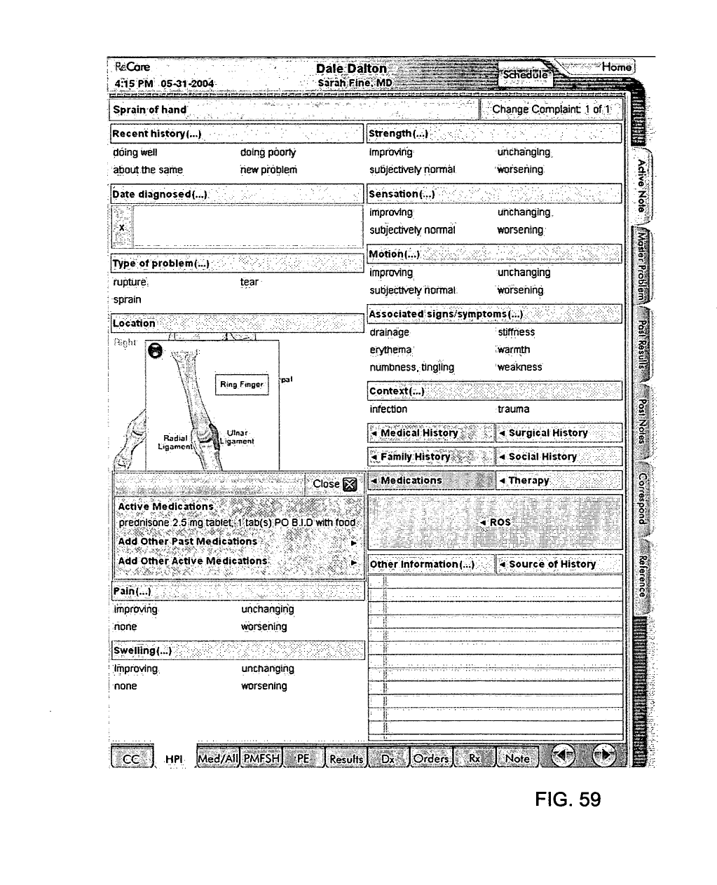

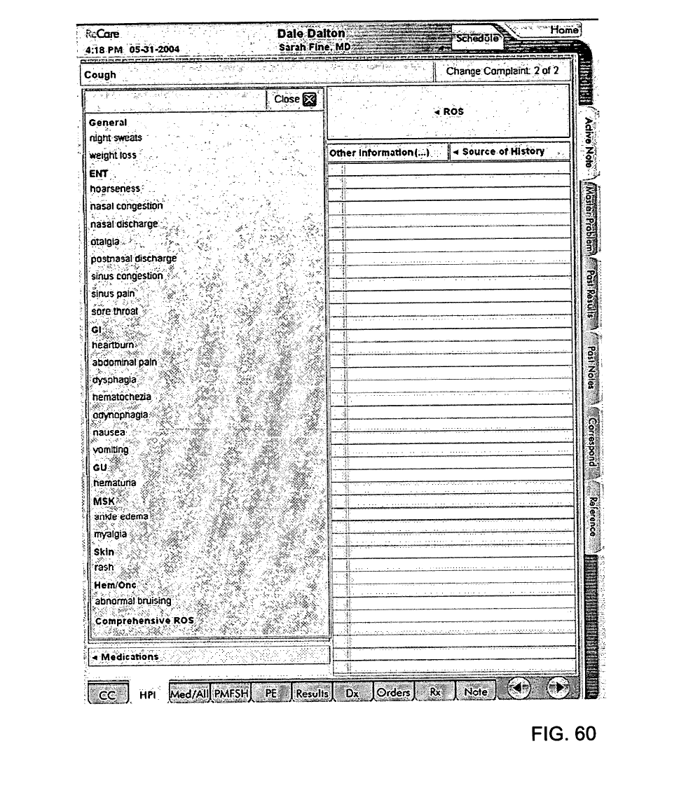

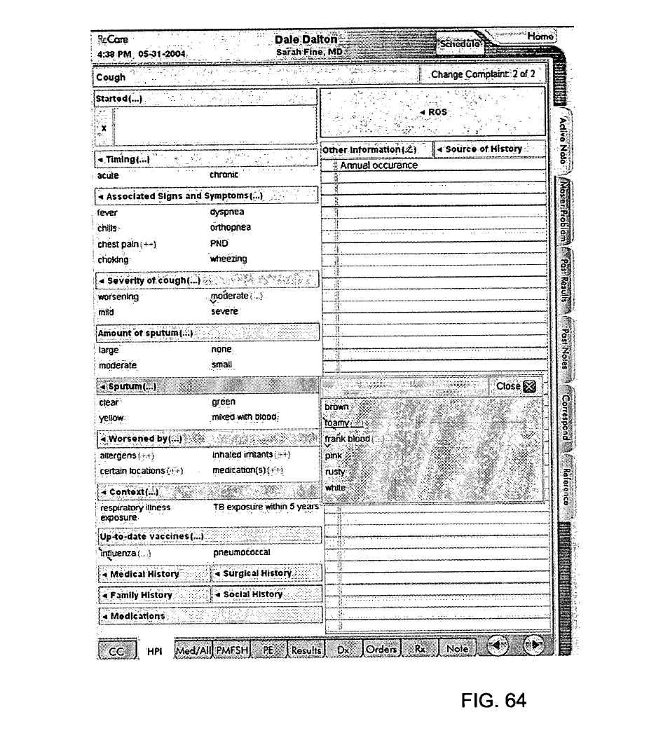

FIGS. 59, 60, and 64 illustrate alternative embodiments of interface fly-outs. FIG. 59 depicts a fly-out including links to subsequent fly-outs as indicated by the arrows. FIGS. 60 and 64 illustrate fly-outs with selectable items sorted by category. When selected, items may indicate selection by a change in the graphic or the appearance of an underlying or overlying check mark or slash.

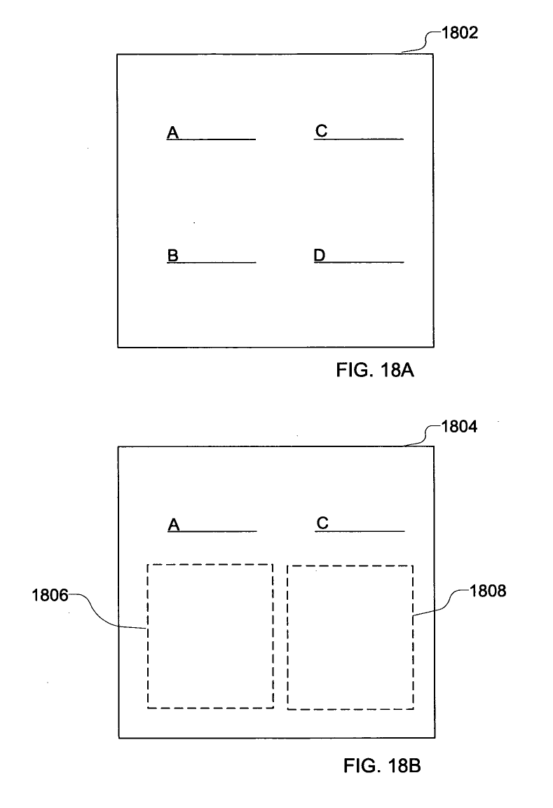

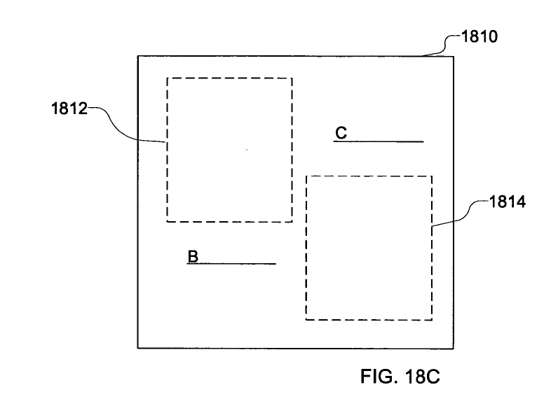

The location of the fly out may be of particular interest depending on which hand the physician is using or prefers (i.e. left handed or right handed). FIGS. 18A-18C depict an exemplary embodiment of an interface screen. For example, as shown in FIG. 18A, an interface 1802 may include categories A, B, C and D located in various locations about the screen. In this exemplary embodiment, categories A and B are depicted on one side of the screen, while categories C and D are depicted on the other side of the screen. FIG. 18B depicts an interface 1804 in which a fly out results from the selection of category A. If a right-handed individual were to select category A, a fly out in location 1808 would be covered by the individual's hand or arm. As such, the individual may prefer that the fly out be located at location 1806. However, a left-handed individual selecting item A may prefer that the location of the fly out be location 1808. As depicted in FIG. 18C, when an item or category C is selected in interface 1810, a right-handed person may prefer the location of the fly out to be location 1812, while a left-handed person may prefer the location of the fly out to be location 1814.

The interface may be provided with a method of selectively locating fly outs to accommodate the difference in handedness. In one exemplary embodiment, the encounter device may include data associated with the user that includes a hand preference. In another exemplary embodiment, the preference may be stored on the interface device. In either case, the interface may select locations for the display of fly outs based on the handed preference of the user.

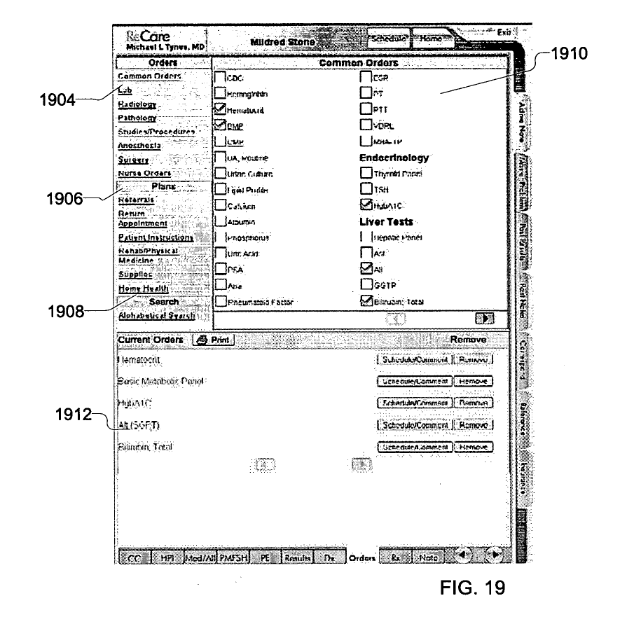

FIG. 19 illustrates an exemplary interface associated with an order stage of a medical workflow. The order stage of the medical workflow includes identifying tests, referrals, rehabilitation programs, and other on going treatment programs. This exemplary interface includes an order category list 1904. The order category list 1904, for example, includes links to common orders, lab orders, radiology orders, pathology orders, studies and procedures, anesthesia orders, surgery orders, and nurse orders. Selection of an item in the category list 1904 results in the display of related items in an order area 1910. For example, selection of “common orders” results in the display of a set of commonly ordered items in the order area 1910. Other category lists, such as plan list 1906 and Search list 1908 may also be included.

Common orders may, for example, include blood tests, urine tests, and other commonly ordered tests. In one exemplary embodiment, the common orders are adjusted based on the practice habits of a specific physician or the practice area of the physician. The listing may be adjusted through the encounter system either manually or automatically. In one example, a list of common orders is provided, that is customized for the physician's specialty. In another example, the encounter system includes artificial intelligence for determining a list of common orders.

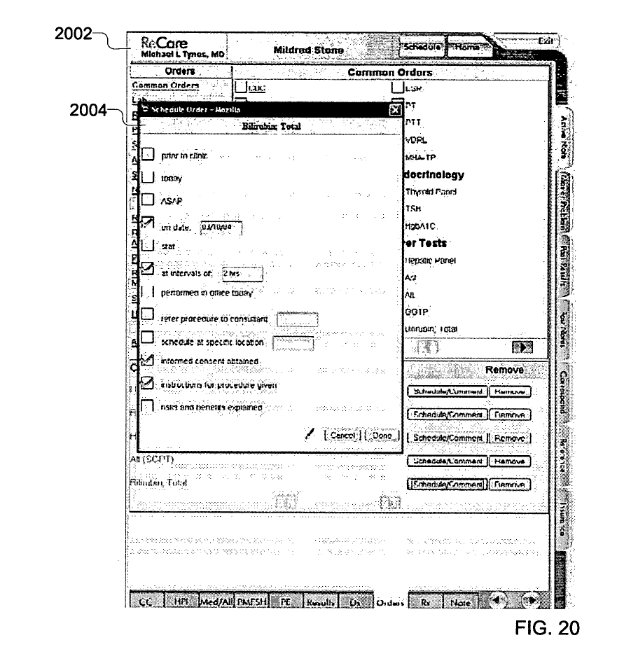

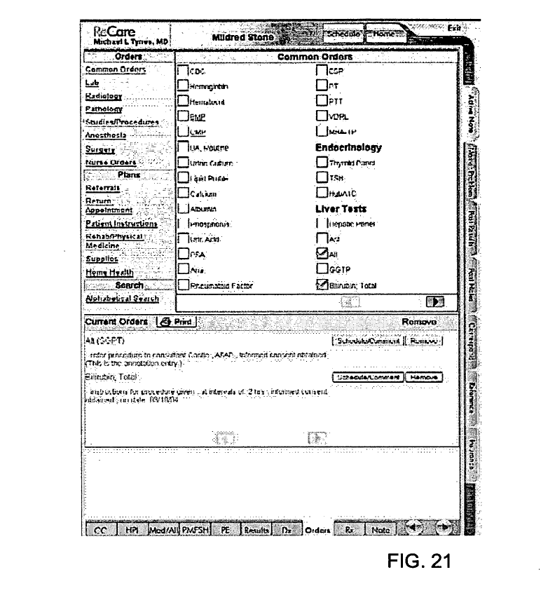

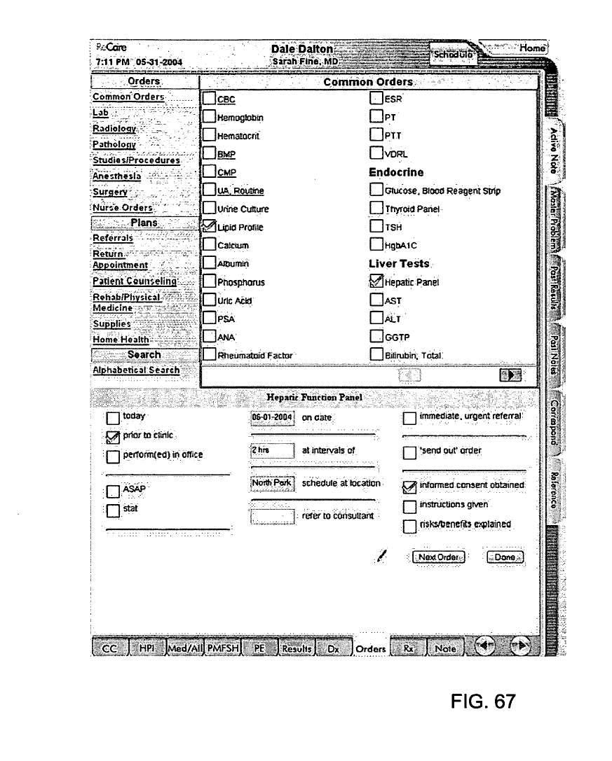

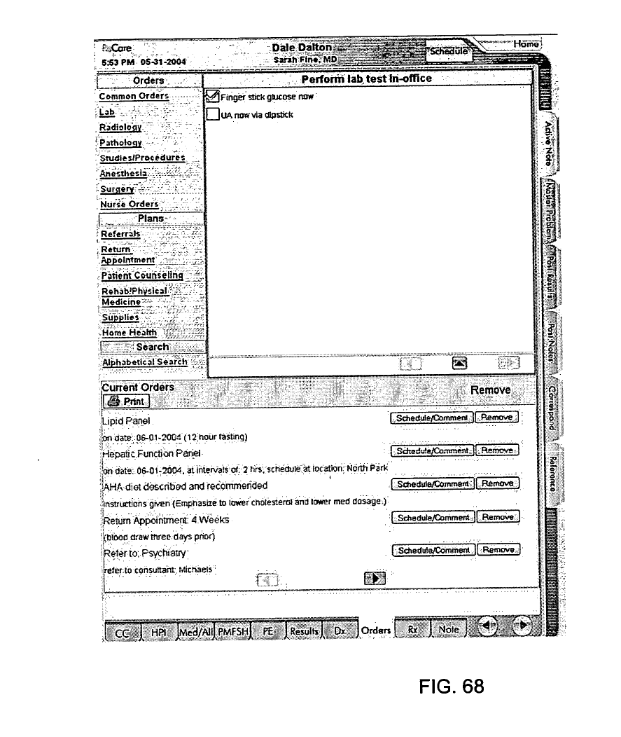

Items in the order area 1910 may be selected, such as through activation of a checkbox or radio button. When an item is selected, the item may be listed in a current orders area 1912. The current orders area 1912 may list a set of previously selected orders and provide the ability to schedule orders, comment on orders, or remove the orders. For example, the current orders area 1912 may include schedule/comment buttons associated with each item. Selection of the schedule/comment button may present a fly-out screen, such as that depicted in FIG. 20. Specific data associated with the test or order may be entered, such as scheduling information, patient instructions, and order specifications. The fly-out may also include a link to an annotate interface. When the fly-out is completed, information entered into the fly-out may be presented in the current order area 1912 and associated with the order. FIG. 21 illustrates a summary of information associated with an order in the current order area 1912. FIGS. 67 and 68 illustrate alternate embodiments of interfaces for placing orders. Once selected, an order is added to the list. When an order within the list is selected, a set of elements, such as drop-down menus, selectable buttons, bi-state elements, and tri-state elements, are provide for entry of additional data relating to the order.

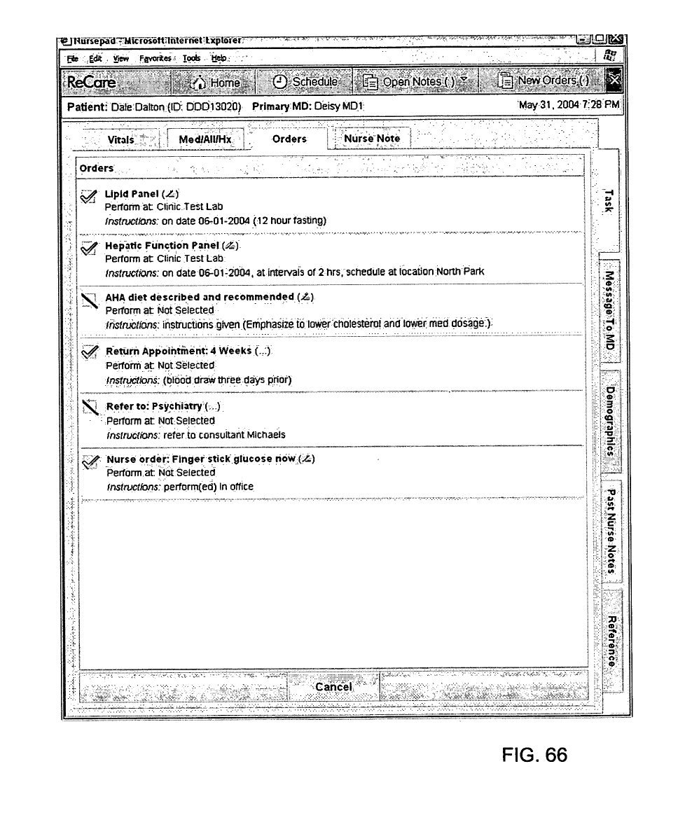

Selection of other categories presented on the category lists may result in the display of relevant options in the display area. Subsequent selection of a relevant option may provide an item in the current orders area and access to an interface for entering additional information about the order. The current orders may be transferred to the encounter system. A nurse interface may access the orders and indicate whether the orders were completed. FIG. 66 illustrates an exemplary nurse interface associated with orders. The nurse may perform tasks associated with orders, such as draw blood or obtain a urine sample. The order may be annotated and selected (checked or slashed) to indicate status of the order.

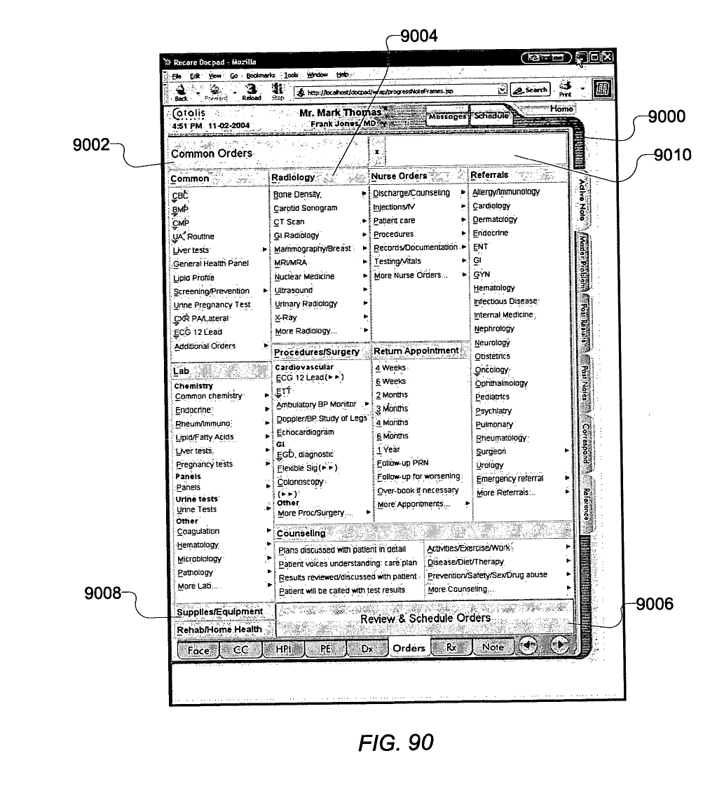

FIG. 90 illustrates another exemplary embodiment of an order interface for requesting tests and orders. For example, the order interface 9000 may organize orders based on who performs them or based on the type of order. Orders may generally be selected by clicking on them. The interface may indicate scheduling or acceptance of an order with a green checkmark.

In one particular embodiment, the order interface begins by displaying a set of common orders, as indicated by the common orders area 9002. The orders may be categorized or listed under categories based on their frequency of use, based on who performs them, such as labs, radiology, nurses, or based on the types of procedures, such as surgeries or counseling. Further, the physician may schedule follow-up appointments and provide referrals.

In one exemplary embodiment, a set of entries is listed under a category, such as “radiology” 9004. Tests that may be ordered under “radiology” include bone density, cat scans, x-rays, and other radiologically performed tests. Orders that are uncommon may be listed, for example, under the “more radiology orders” area. For categories that are unusual, or rarely used, such as “supplies and equipment” and “rehab and home health” categories, buttons 9008 may be provided to facilitate fly-outs for order selection.

In addition, if a particular order is difficult to find, a keyword search may be provided using control element 9010. In one particular embodiment, the keyword search returns results listed by category.

Once the orders have been selected using the selection screen or though fly-outs provided from the order selection interface, the physician or medical professional may select the “review and schedule orders” button 9006.

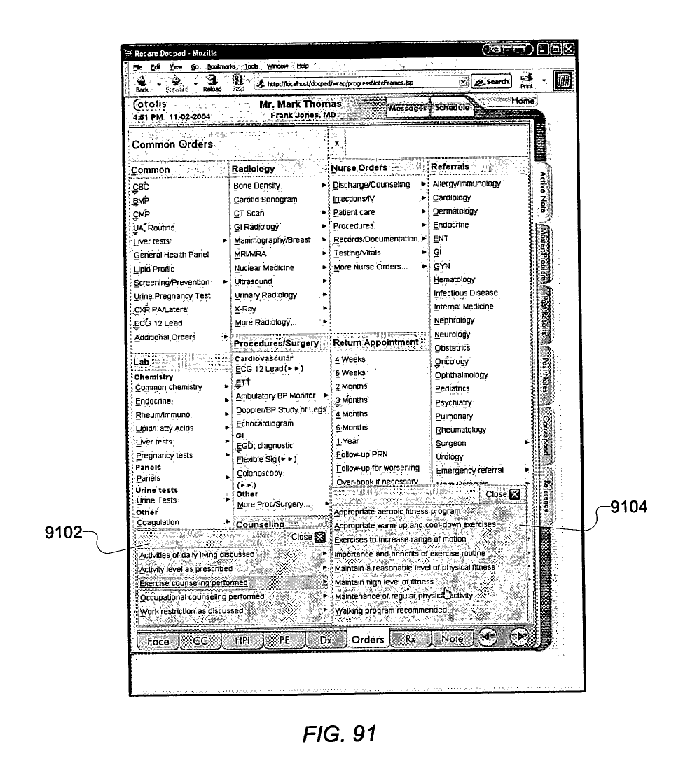

FIG. 91 illustrates an exemplary embodiment of an order interface in which a test listed under a category further includes sub-categories. Alternatively, when an uncommon set of orders is provided with a button, fly-out windows may be provided to allow for access to sub-lists of orders. For example, when a sub-category is selected, a fly-out 9102 may be provided that includes further options. Those options may include further options that result in a fly-out 9104 being displayed and the ability to select one of the orders or tasks displayed within fly-out 9102 and/or 9104.

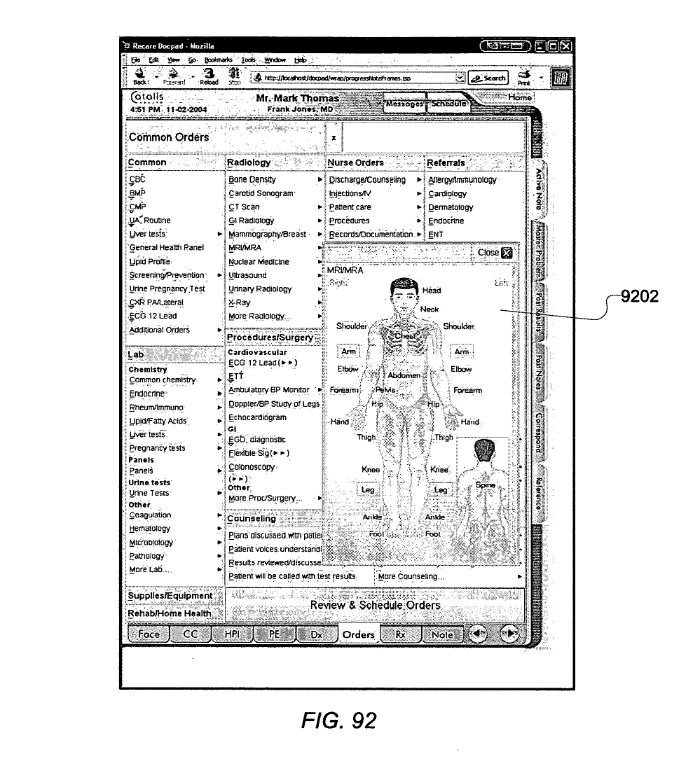

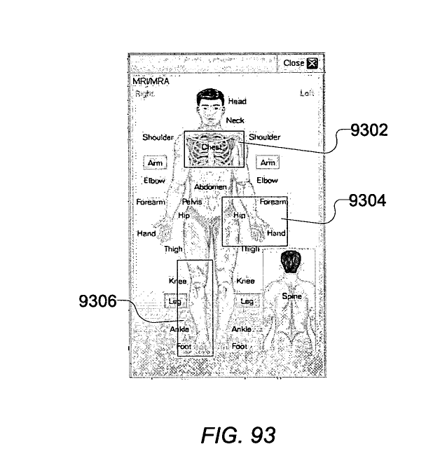

In another exemplary embodiment, a test may be associated with a specific region of the body. This is particularly useful in the case of radiological tests, such as x-rays, MRI's, cat scans, and other orders and tests that have a region or location associated with the test. When such a test is ordered, an image of a body may be provided as illustrated in FIG. 92. The body image, such as image 9202, may be provided to the medical professional, allowing them to select a region of the body based on keywords or, alternatively, based on graphical selection of a region of the body. In the example shown in FIG. 92, a medical professional is ordering an MRI/MRA and has selected the chest region, as indicated by the display of internal bones in that region. FIG. 93 illustrates an alternative embodiment in which a physician may select a region using a box tool. For example, the physician may draw a box in the chest region, such as box 9302, resulting in the display of internal body parts on the image of the individual. Alternatively, the physician may box other regions of the body, such as regions 9304 and 9306. Once these regions are selected, the internal bone structure of the patient may be illustrated. Alternatively, the indication of the region being selected may include drawing that region in negative or drawing that region to depict a MRI scan, such as using fluorescent coloring or other colors. The image may further include a button that allows for the selection of the back or another region of the body.

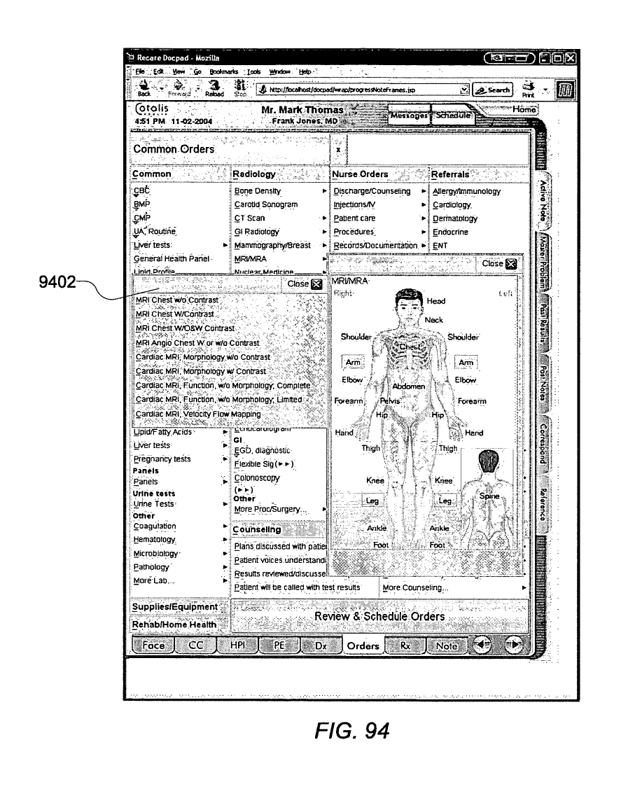

FIG. 94 illustrates a further embodiment in which regions of the body that are complex or have certain terminology associated with them to indicate the location or type of scan may be selected using a fly-out menu, which provides for common terminology that is used by, for example, radiologists, in determining exactly which type of scan to perform. Such visual indications or precise medical terminologies provide for more accurate transfer of orders and requests to other departments, such as radiology or labs. Once the test region is identified or selected, that information may more easily transferred to other interfaces associated with the encounter system, effectively indicating to the individual performing an order, such as a radiology assistant or radiologist, where and how to perform the particular test.

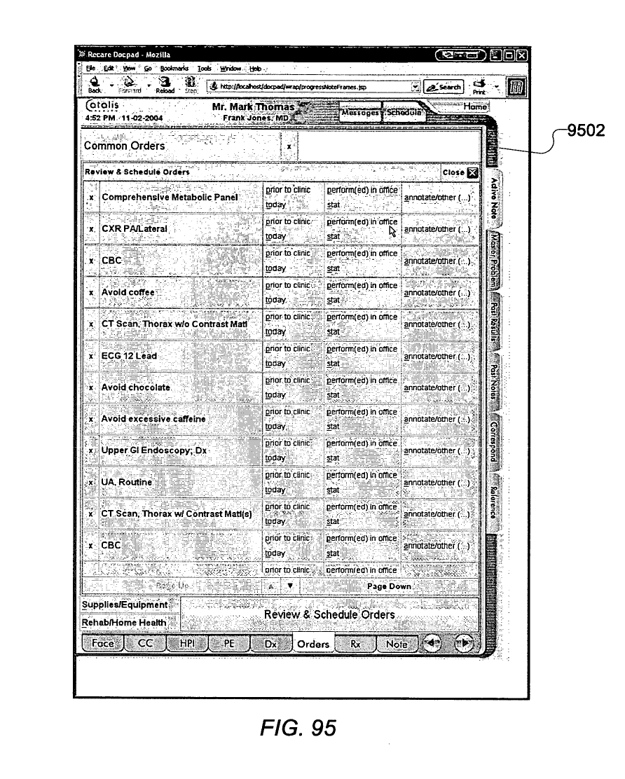

Once the tests and orders have been selected, the physician may select the “review and schedule orders” button, which results in the display of tests and orders, as illustrated in FIG. 95. The review interface 9502 may provide a listing of orders that have been selected by a physician and may allow the physician to further indicate or direct when and how the order should be performed. The review screen 9502 may permit the physician or medical professional to select when, how and where to perform the order, such as whether to perform the order in the clinic during the current visit, to perform the order immediately at a lab, or direct the patient to visit another facility on another day. The order screen may further allow for the annotation of an order providing further instructions for performing that order.

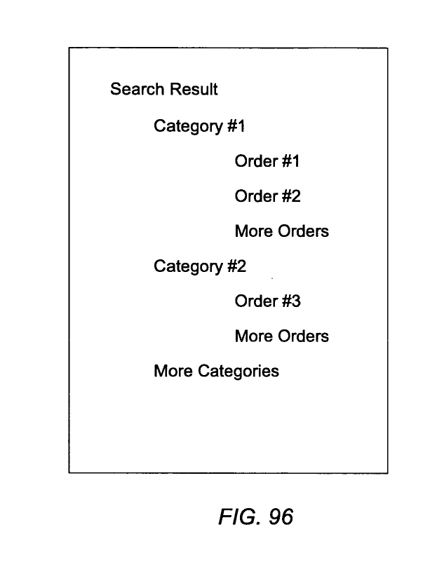

Throughout the interface, various interfaces may include the ability to perform a keyword search, such as in the diagnosis interface, the order interface, the prescription interface, or on the face sheet itself. The results from that search may be provided alphabetically. Alternatively, the results from the search may be provided under category headings, such as illustrated in FIG. 96. For example, when a search is entered on the orders interface, the search results may be presented or listed based on their category. The search results may list entries by category, such as radiology, lab results, or when a result of the search is uncommon or generally unused, it may be listed or accessible through the “more categories” selection button. In one exemplary embodiment, a physician may search for “liver” in the order interface. The search results may be ordered by categories such as “lab” and “radiology.” For example, lab related orders, such as liver enzyme tests, may be listed under lab and radiology related orders, such as liver ultrasounds, may be listed under radiology. When a category includes several tests or orders or when a search result includes more than a few categories, additional links may be provided to locate the additional search results that are not listed. For infrequently used results, the tests and orders may be accessible by the “more categories” link.

Once an order is specified, the physician may proceed to another interface, such as the prescription interface or a notes interface. In a notes interface, the physician may be presented with a narrative of what has been performed and coding options for coding orders and the examination. In any one of the screens, such as the face sheet or on the notes screen, an indicator may be provided that warns a physician that new information has been entered into the system subsequent to the visit with the patient. For example, a physician may wait to sign a note until all of the test results are in. However, between the arrival of the test results and the signing of a note, further information may be provided, such as from a patient's subsequent visit to clinic or to a hospital, or by a subsequent finding that alters the relevancy of the note. With a warning that additional information has become available, a physician may provide a notation in the note indicating that new information has arrived or may enter a subsequent entry into the system following their acceptance of the current note.

In another exemplary embodiment, the orders may be checked against payer rules. For example, a payer, such as a government entity, may allow a test when a finding or condition is noted. In one particular embodiment, findings are associated with International Classification of Disease codes (ICD-9 codes). Rules may support ordering of specific test when particular ICD-9 codes are recorded or noted. The encounter system may check order codes, such as Current Procedural Terminology codes (CPT codes) against ICD-9 codes and provide alerts when the orders do not conform to payer rules. In addition, the encounter system may provide an interface element, such as a fly-out window including a list of remunerable codes or including elements to allow update of patient data.

A notes page may also include the ICD-9 codes associated with findings, CPT codes associated with orders, and Evaluations & Management codes (E&M). Alerts may be provided for noncompliance with payer rules on the notes page. In addition, the notes page may provide a summary of the visit and, through the E&M codes, aid the physician in adequately reflecting the nature of the patient encounter and, thus, the overall remuneration owed by the payer for that encounter.

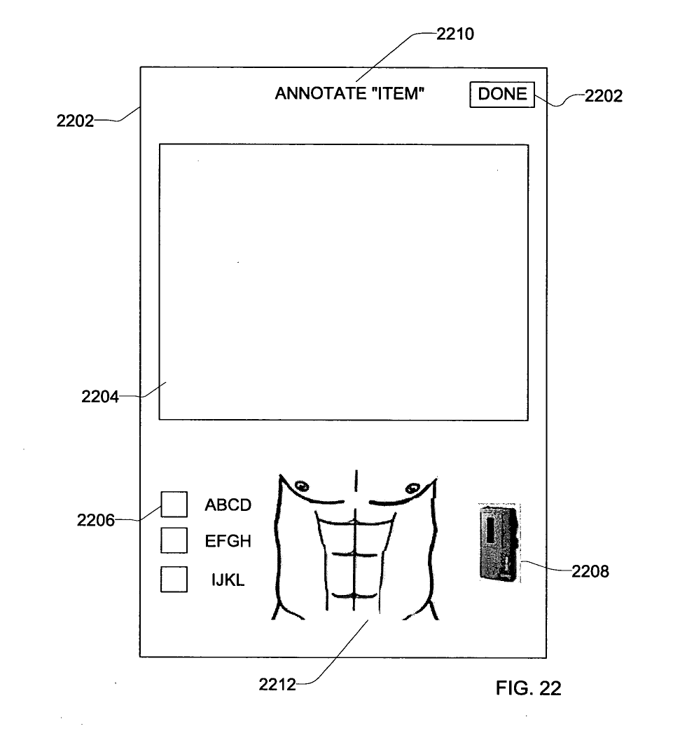

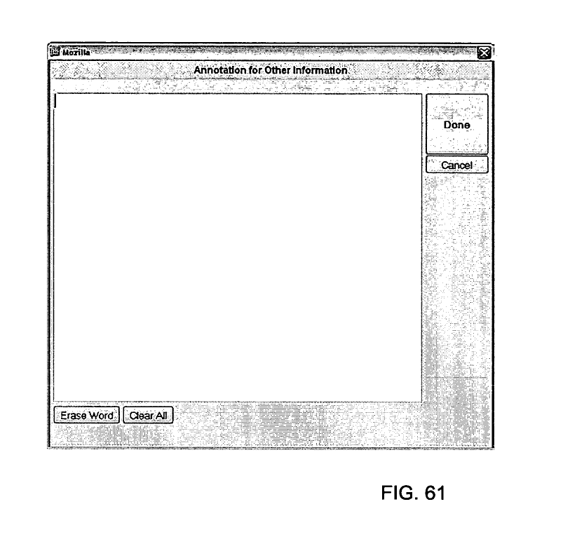

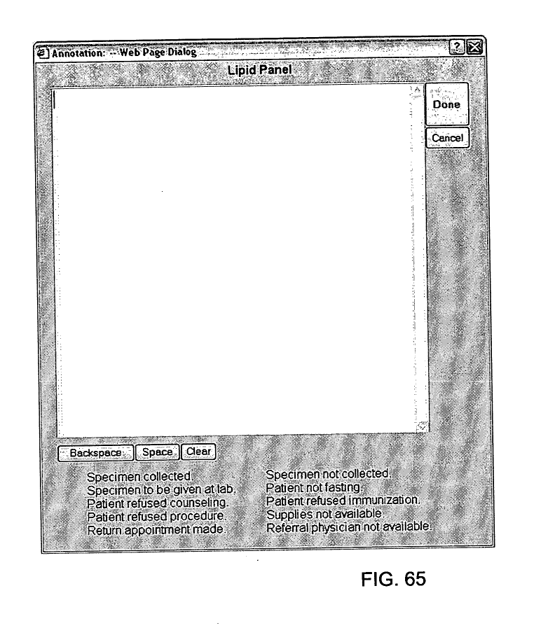

Each stage in the medical workflow may also provide access to annotation screens. For example, each category heading or item listed under a category heading may provide a link to an associated annotation page. FIG. 22 illustrates an exemplary annotation interface 2202 associated with an item or category. For example, in the annotation interface 2202, the item or category may be listed in a heading 2210. The annotation interface 2202 may provide an area 2204 for entering text information. In a touch screen display, the area 2204 may accept handwriting and convert it to text data. The annotation interface 2202 may also include a list of frequently used comments 2206. A medical professional may, for example, select a frequently used comment. The comments 2206 may be adaptive or user customized. The annotation interface 2202 may also include an icon or link 2208 that activates voice recording for receiving dictation. In another example, the annotation interface 2202 may permit annotation or drawing over diagrams. For example, a free draw area 2212 may be provided or a figure of an associated anatomy may be presented for drawing annotations. FIG. 61 illustrates an alternative embodiment including a text annotation fly-out. FIG. 65 illustrates an alternative embodiment of an annotation fly-out that includes selectable canned text. In this exemplary embodiment, the annotation relates to an order and the canned text relates to common annotations associated with the order.

The annotation interface may be implemented as a fly-out layer or a separate screen. In one exemplary embodiment, the annotation is associated with or modifies a specific finding, e.g. “severe” modifies “pain” which modifies “headache”. In one exemplary embodiment, the annotation and the finding map to a controlled medical vocabulary that maps specific terms to specific medical concepts. The annotation and finding association may be used by grammar rules as discrete inputs for prose narrative generation. Predictors of likely actions may also use the annotation and finding association.

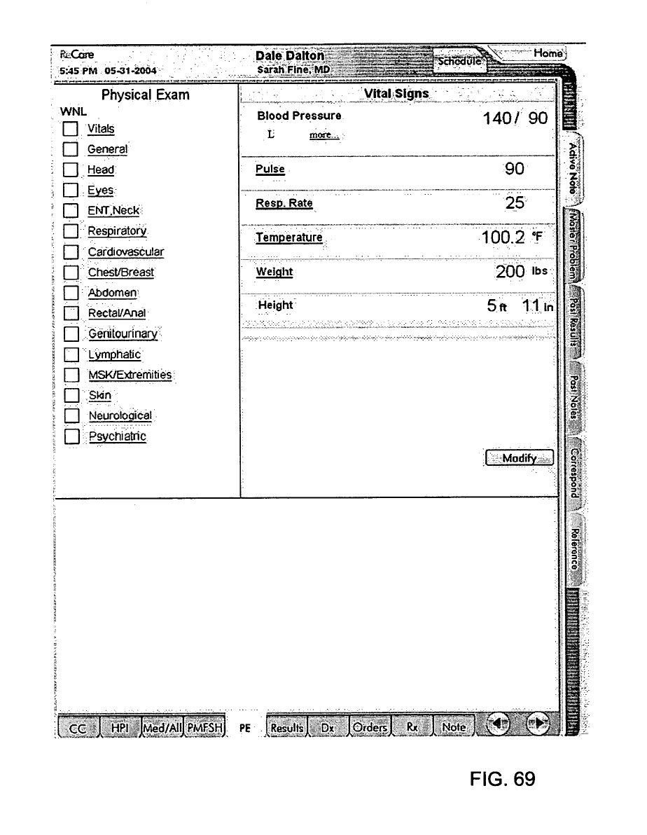

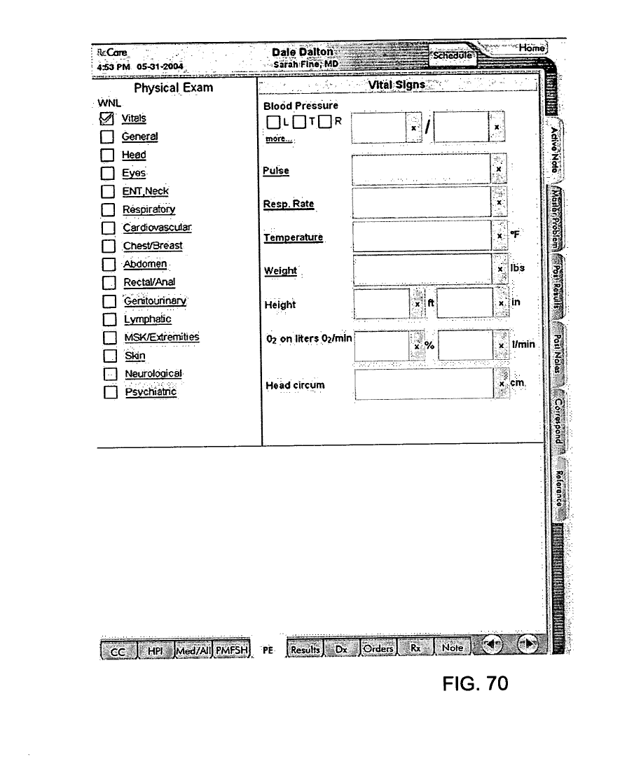

An exemplary physical examination stage interface is illustrated in FIGS. 69 and 70. If a nurse has obtained vital sign data, the vital sign data may be displayed, as depicted in FIG. 69. Alternately, if the vital sign data is absent or if a physician selects to reenter the vital sign data, an interface such as that illustrated by FIG. 70 may be provided.

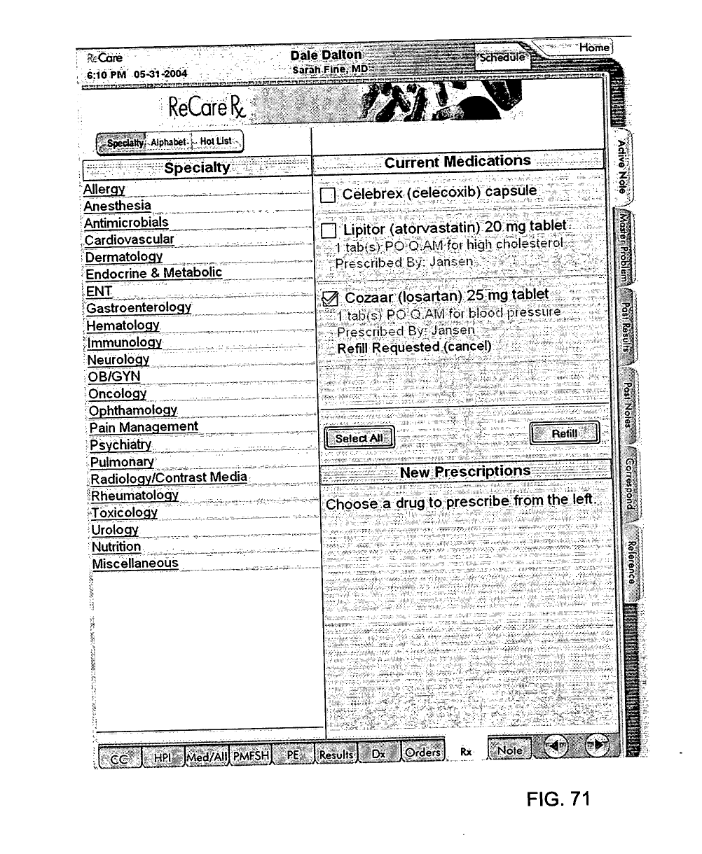

FIG. 71 illustrates an exemplary prescription interface. If a patient requests a refill, such as through interaction with a nurse or interaction with a patient interface, the request may be displayed for approval or cancellation by the physician. For example, a refill button may be provided to facilitate refills for selected items. In addition, a “cancel” item may be provided in proximity to a patient request for refill.

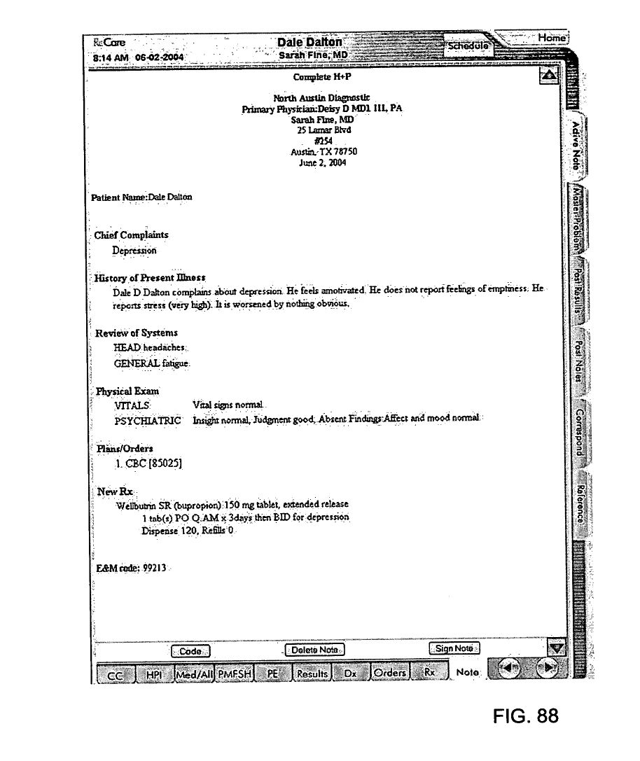

Once an encounter is complete, the physician may access a notes interface, such as that illustrated by FIG. 88. The notes interface may include narratives and annotations associated with stages within the medical workflow. In addition, the notes interface may include ICD-9 codes, CPT codes, and E&M codes associated with the findings, orders, and overall encounter rating. In one exemplary embodiment, an alert message may be provided when CPT codes conflict with payer rules. Additionally, alerts may be provided to encourage revisiting stages within the workflow to conform to payer rules, justify a test, change a prescription to conform to a formulary, or reevaluate high-risk findings to meet malpractice insurance carrier rules.

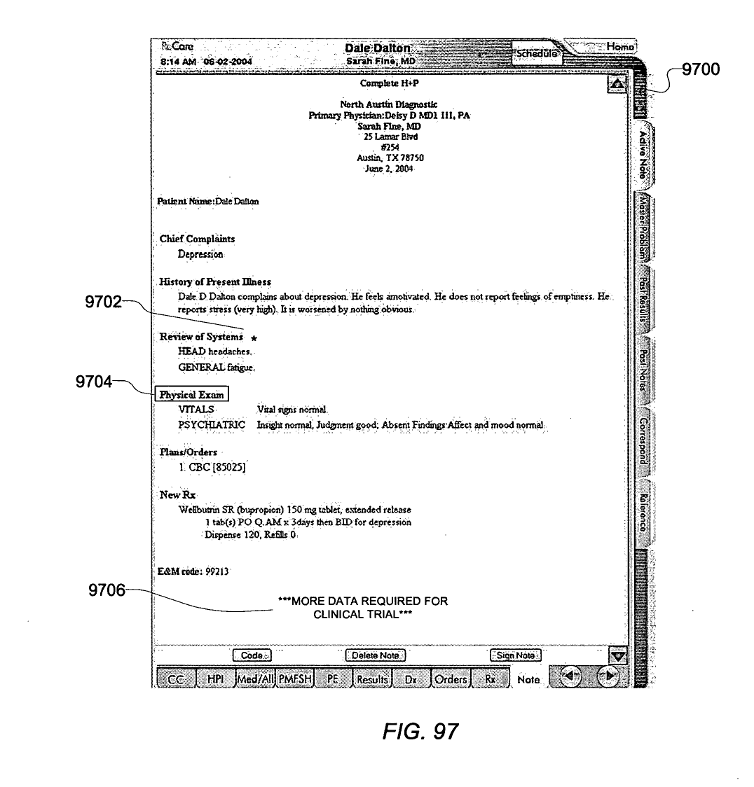

FIG. 97 includes an illustration of a physician's note, such as interface 9700. The interface may include indications that information is missing, such as information desired to complete an exam in relation to a medical trial. For example, indicators 9702, 9704, and 9706 may provide warnings to a physician or medical professional that additional data is suggested. For example, indicators 9702 and/or 9704 may be used to indicate that specific information associated with a step in the medical encounter workflow is missing. Alternately, a generally statement 9706 may be provide by itself or in combination with other indicators, such as indicators 9702, and 9704, to suggest collection of additional data. In alternative embodiments, the indicators may inform a medical professional that information is missing to justify an order based on payer rules, such as Medicare/Medicaid rules or medical plan rules.

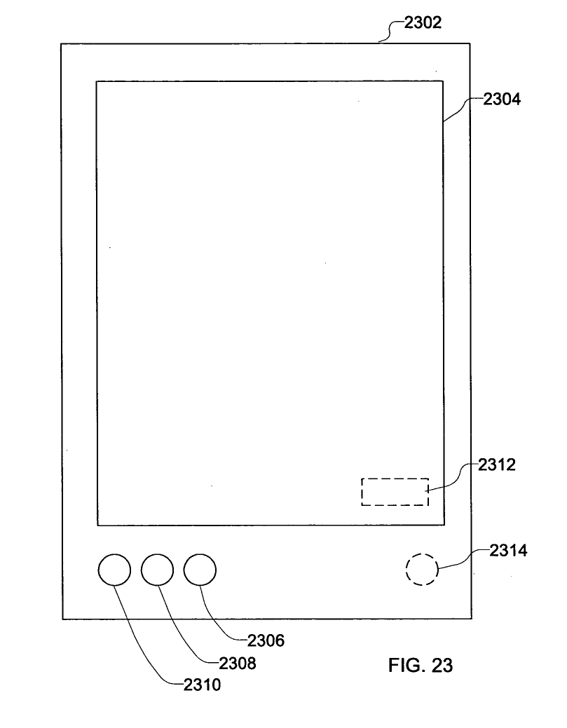

The interfaces, such as the patient interface, nurse interface, and physician interface, may be presented on an interface device. In one exemplary embodiment, the interface device is a pad or ultra-portable computer with a wireless interface to the encounter system, as illustrated in FIG. 23. The device 2302 may include a display area 2304 and a set of buttons 2310, 2308 and 2306. For example, the buttons 2310, 2308, and 2306 may provide for functionality, such as display control and power control. When interviewing a patient or working on confidential information, a medical professional may utilize a button to darken the screen. The button may be implemented as a hardware feature 2314 or as a software interface feature 2312. In one exemplary embodiment, the display 2304 may turn off or reduce brightness. In another exemplary embodiment, a fly-out or blank screen interface may be displayed, covering the previously displayed information. A second activation of the button or a gesture on the display may brighten the screen.

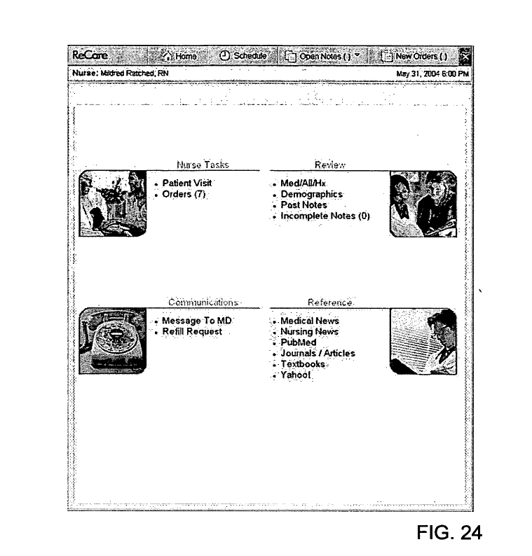

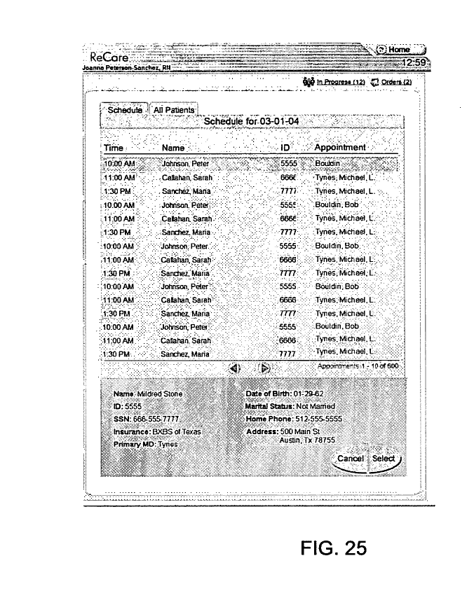

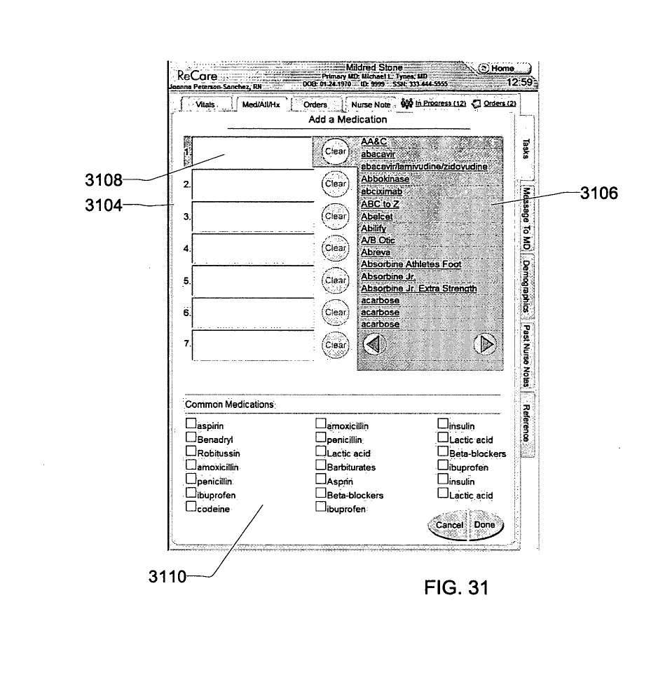

The encounter management system also includes a nurse interface. FIGS. 24 through 39 illustrate an exemplary nurse interface. The nurse interface may include an entry interface, such as the interface illustrated in FIG. 24. Once a nurse is logged-in, the entry interface may be displayed to provide links to screens associated with nurse related tasks. For example, the entry page may include a nurse task list including patient visits and orders. In addition, the entry page may include links to communications, such as notes from physicians and refill requests; links to review items, such as medical and social history review, demographic information, past notes, and incomplete notes; and links associated with references, such as medical journals, articles, and abstracts. Selection of patient visits may result in the presentation of an interface, such as that illustrated by FIG. 25.

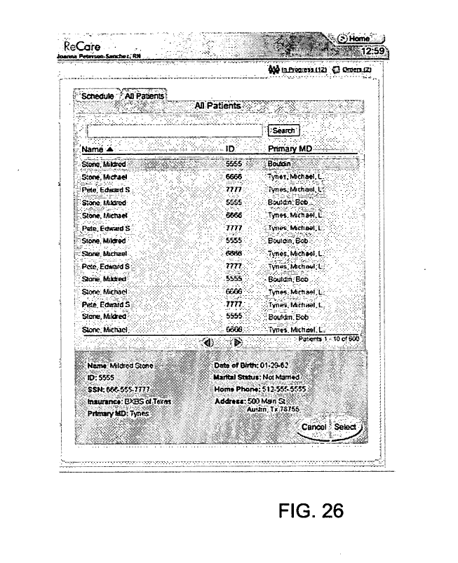

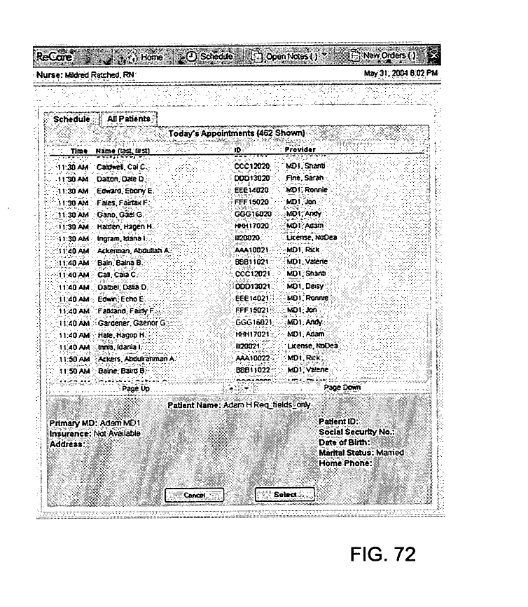

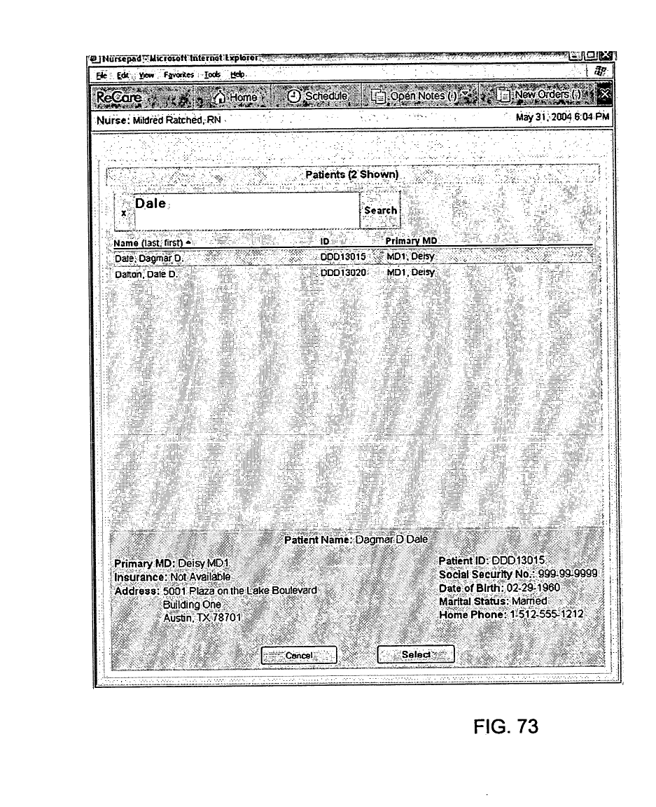

FIG. 25 illustrates an interface for selection of a patient. The patients may be listed by schedule as illustrated in FIG. 25 or patients may be listed alphabetically through the selection of an “all patients” tab, as illustrated in FIG. 26. In alternative embodiments, the interface may permit searching for a patient by name, number, or other identifier. FIG. 72 illustrates an alternative embodiment of an interface for selection of scheduled patients. FIG. 73 illustrates an alternative embodiment for selecting patients alphabetically. The nurse may enter a text string and search for a patient, such as through first letter or first few letters of the patient's last name.

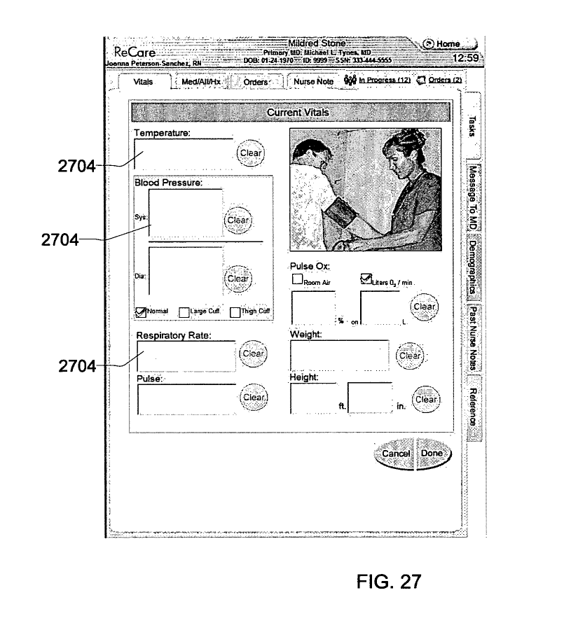

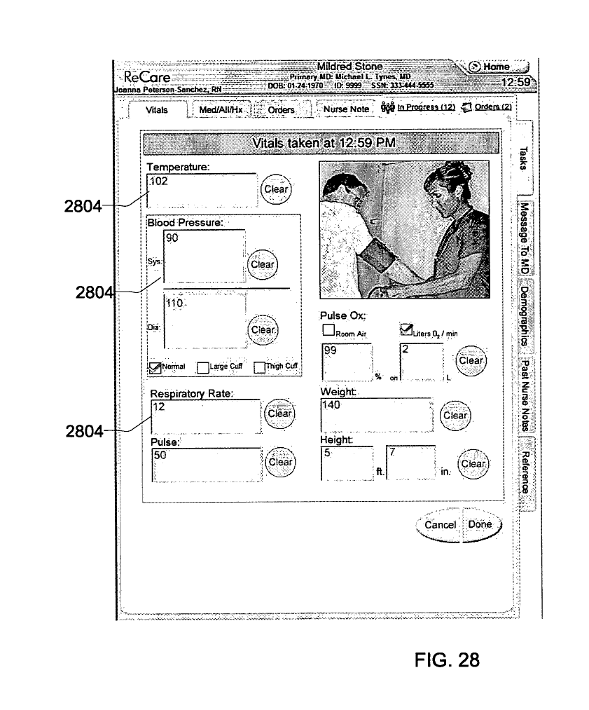

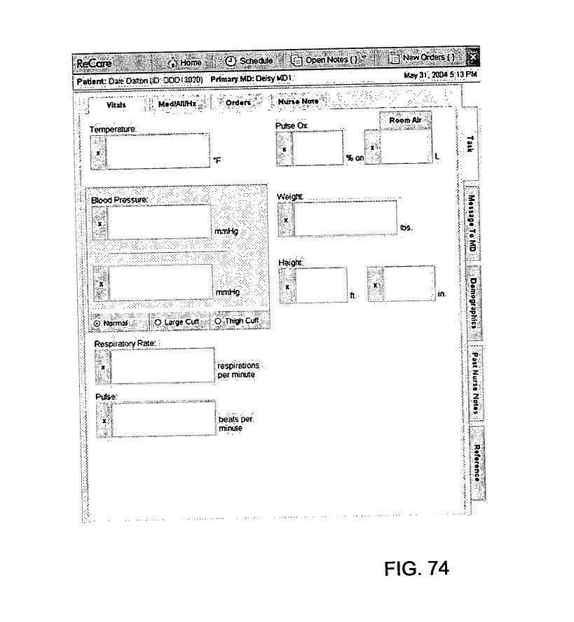

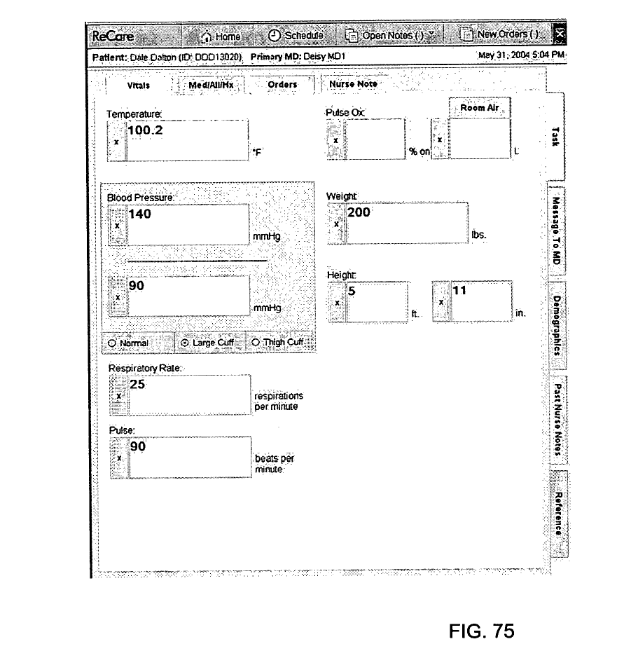

Once a patient is selected, the nurse interface may provide a screen for entering patient medical data, such as the collection of vitals data, as illustrated in FIG. 27. For example, a nurse may collect patient temperature, blood pressure, pulse rate, respiratory rate, weight, and height information. In the exemplary embodiment of FIG. 27, data entry elements 2704, such as textboxes and checkboxes, are provided. A nurse may, for example, as illustrated in FIG. 28, enter text into the entry elements 2804. The system may, for example, receive handwritten text and convert it to digital text. Alternative embodiments are illustrated in FIGS. 74 and 75.

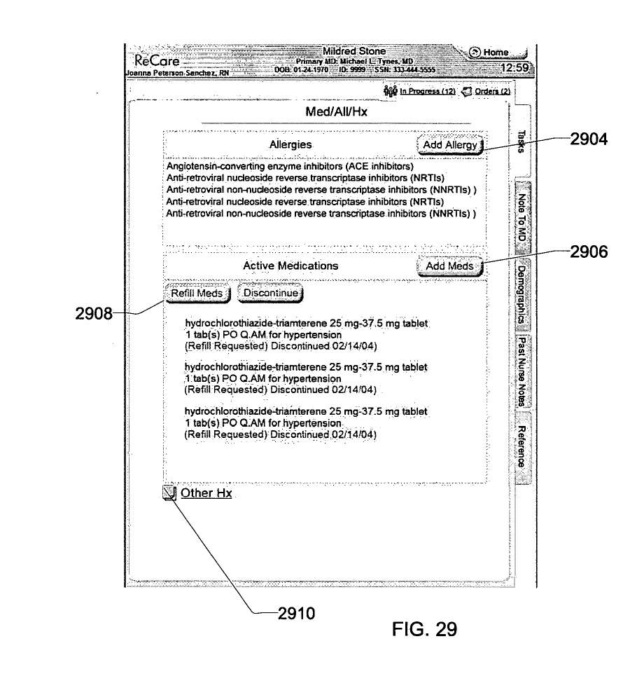

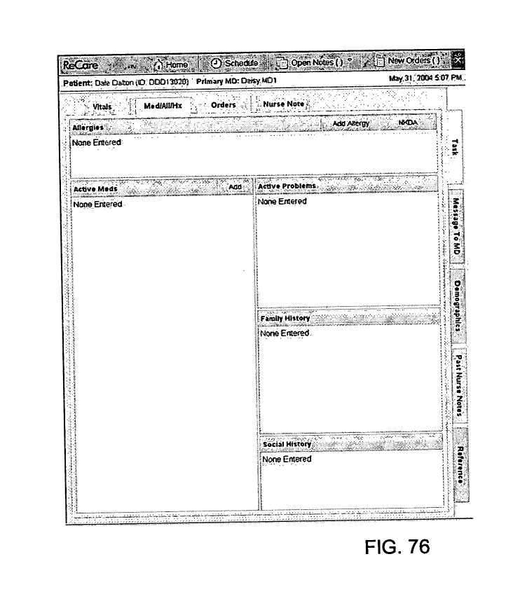

The nurse may also collect current medicine, social history, and allergy information. FIG. 29 illustrates an exemplary interface for accessing medicine, social history and allergy information. For example, the allergies, current medications and refill requests may be displayed on a first screen with links (2904, 2906, 2908, and 2910) to additional entry screens. In one exemplary embodiment, a nurse may request a refill for a medication by selecting a “refill meds” link 2908. The interface may also permit requesting discontinuing of a medication. FIG. 76 illustrates an alternative interface for medical/allergy/PMFSH data entry

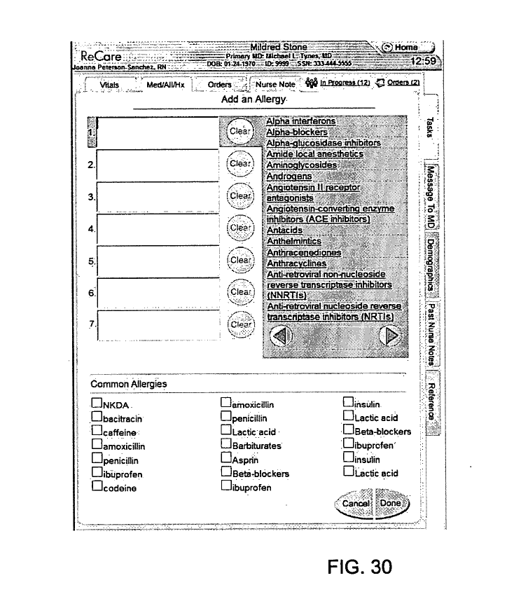

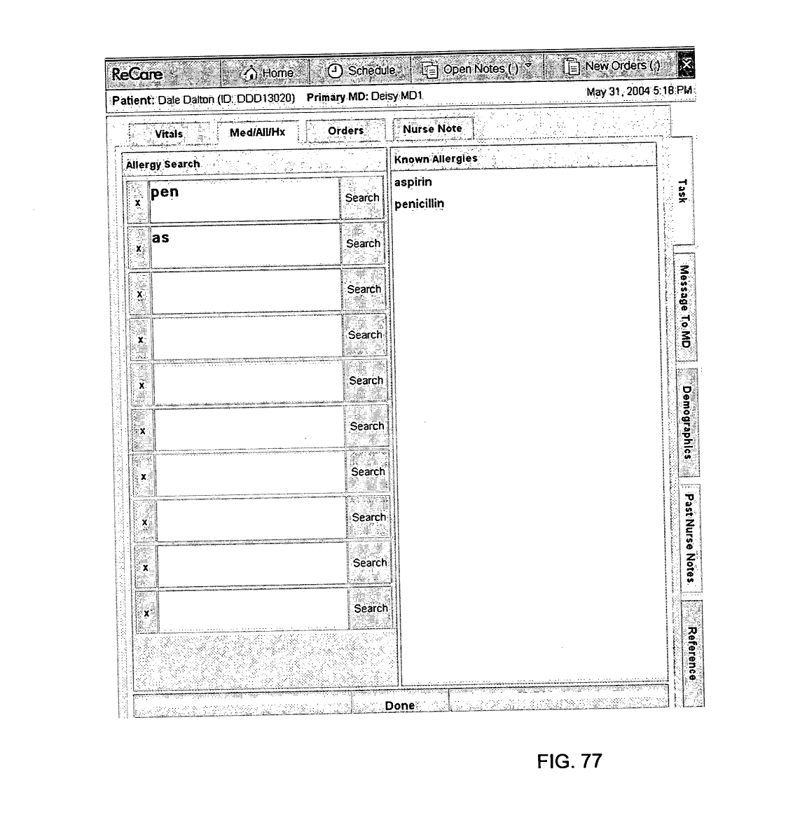

Selection of an “add allergy” link 2904 results in an “add allergy” interface, such as the interface depicted in FIG. 30. The “add allergy” interface includes a set of entry boxes and an associated listing of allergies. In addition, the interface may include a set of common allergies with checkboxes. FIG. 77 illustrates an alternative embodiment.

FIG. 3 1 depicts an exemplary “add medication” interface, which may be accessed by selection of the “add meds” link 2906 of FIG. 29. The “add medication” interface includes a set of text entry boxes 3104. When a text entry box is activated, a list of medications 3106 is associated with the active text entry box 3108. The list 3106 may be sorted in response to entry of text into the text entry box 3108. For example, when a medical professional enters the first few letters of a medication into the text box 3108, the list 3106 may be sorted to present medications having the first few letters or likely to match the entered text. The “add medication” interface may also include a set of commonly selected medications 3110 with associated checkboxes.

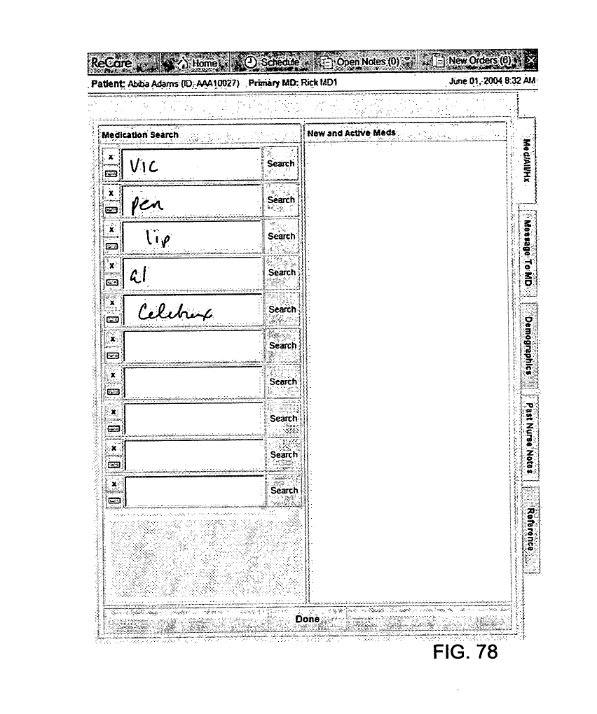

FIGS. 78 through 82 illustrate an alternative embodiment for entering current medicine information. A nurse may handwrite a text string, such as the first few letters of a medicine's name. A set of text strings may be entered into each box, as desired. Once the text strings are entered, each string may selectively be used in a search by selection of the search button. This permits a nurse to quickly enter short hand text associated with each medicine while discussing the medications with a patient and subsequently search and complete the information.

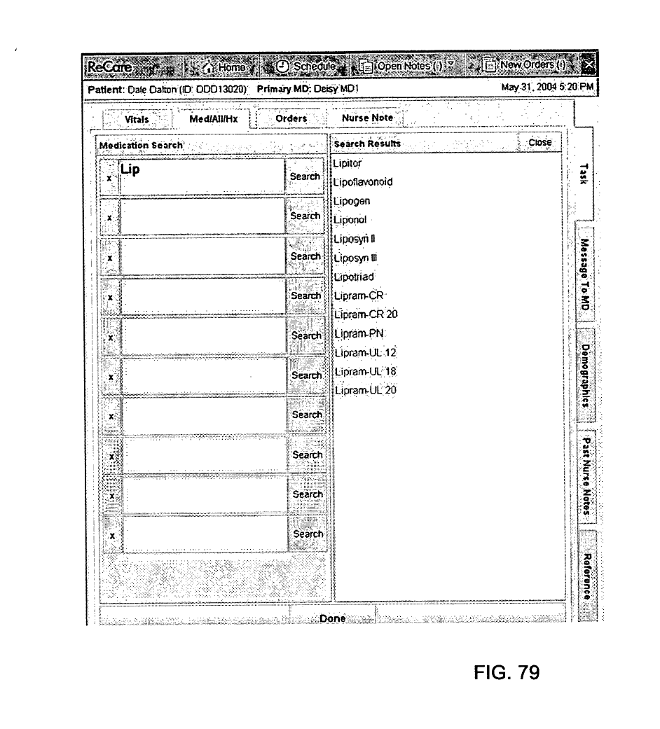

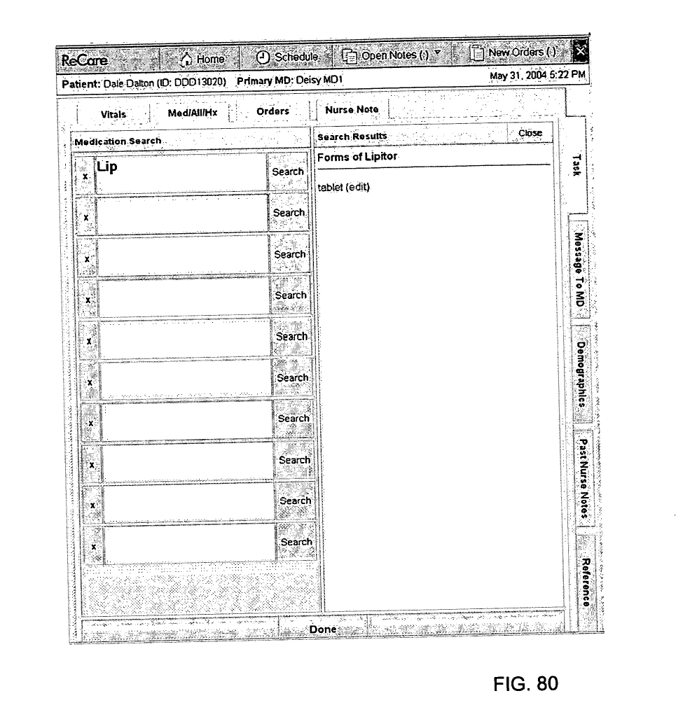

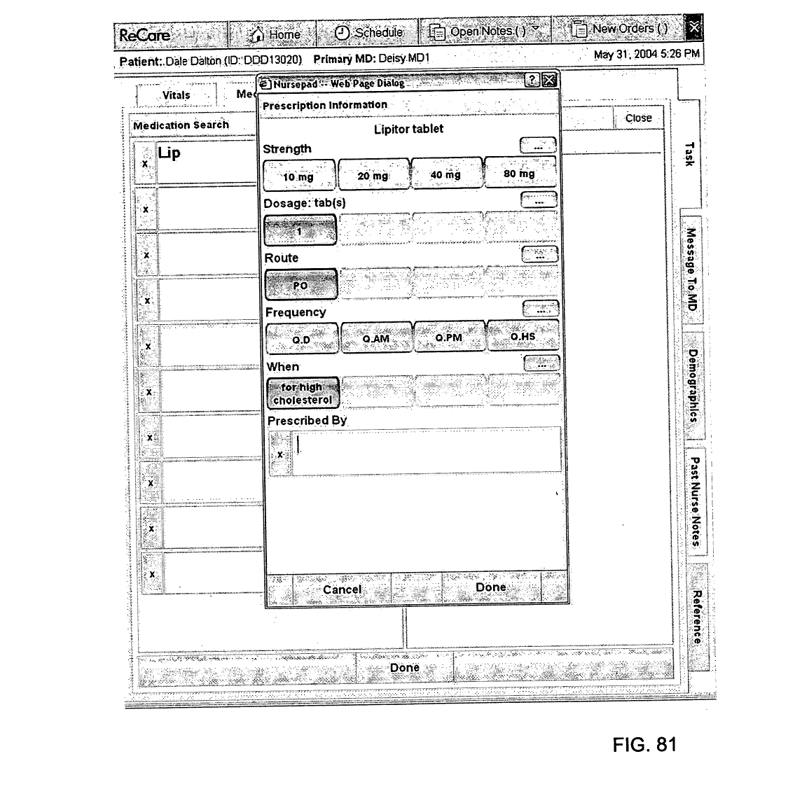

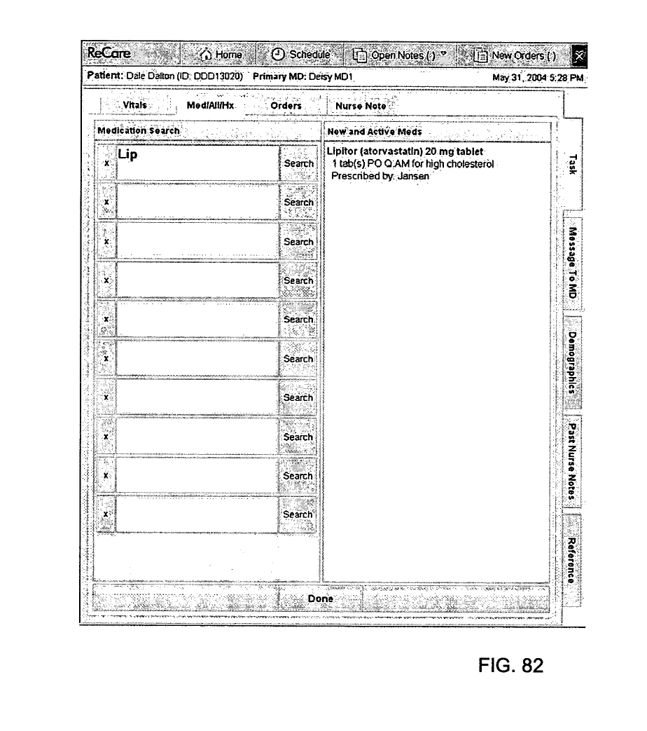

FIG. 79 illustrates a search based on the text string “lip”. Once the search button associated with the text box including “lip” is selected, a list of items having “lip” as their first few letters is provided. As illustrated in FIG. 80, a nurse or healthcare provider may select an item, such as Lipitor. The interface may indicate the forms in which Lipitor is available, such as tablets. When tablet is selected, an interface such as that illustrated in FIG. 81 may be displayed for the entry of the specific dose being taken by the patient. An interface such as that illustrated in FIG. 82 may be displayed showing the entered data.

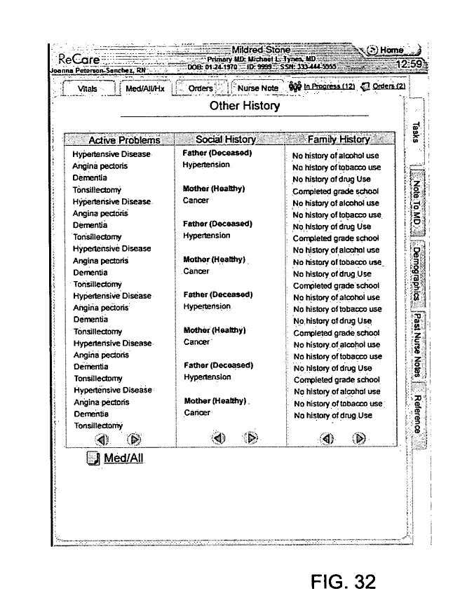

An “other history” interface, such as that illustrated in FIG. 32 may list social history and other patient medical history, such as past surgeries and family medical history. The “other history” interface may, for example, be accessed by selection of link 2910 of FIG. 29.

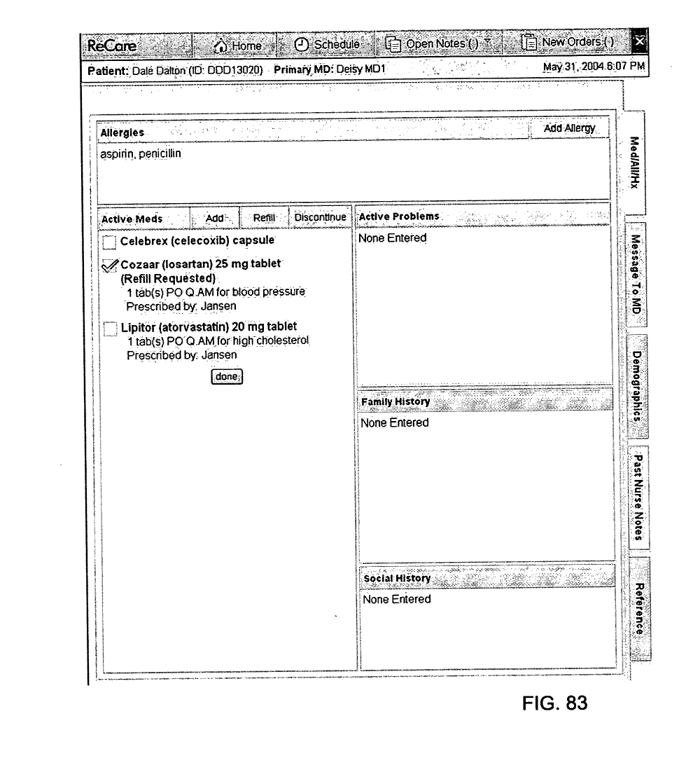

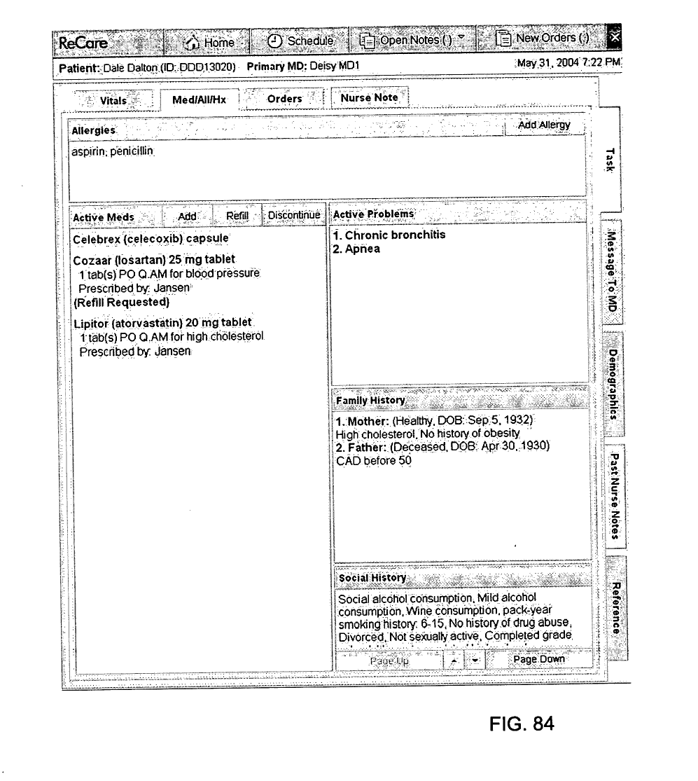

FIG. 83 illustrates an exemplary interface with entered medical information and checkboxes permitting request of refills, which may be activated by selection of the refill button associated with current medicines. FIG. 84 illustrates a populated PMFSH interface.

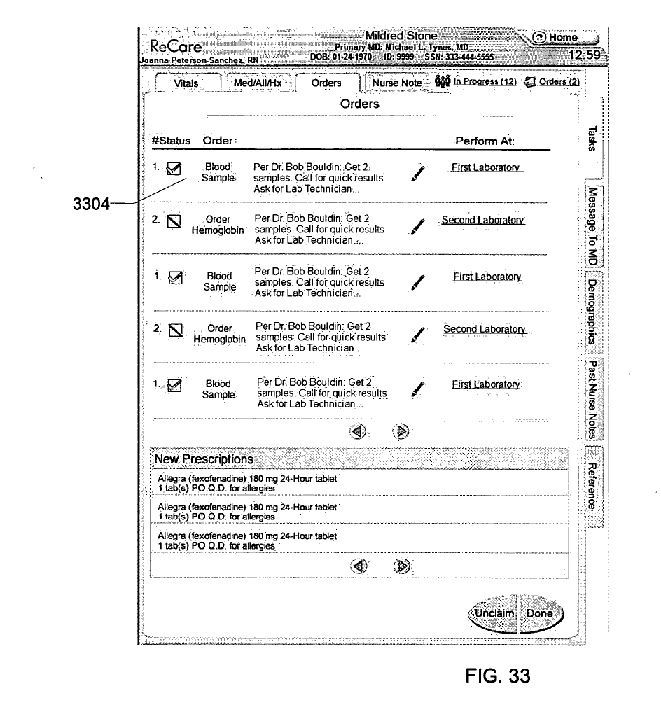

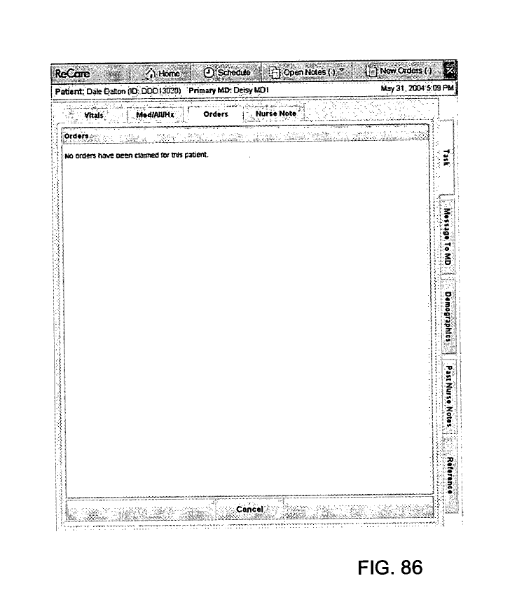

A nurse interface may also include an area for tracking and ordering tests associated with a patient. FIG. 33 illustrates an exemplary order entry interface. The order interface may include information about the status of each order, the type of order, who ordered it, and where the order was sent. For example, a blood sample test 3304 may have been sent to a laboratory and have results available. The status may indicate that the order is available, such as through a check mark. If an order is not complete, the status may be a slash. FIG. 86 illustrates an exemplary unpopulated interface associated with orders. In one exemplary embodiment, when a physician enters orders on a physician interface, the orders may be accessed from the nurse interface through interfaces, such as those illustrated in FIGS. 33 and 86. The nurse may indicate whether the tasks associated with the order were completed and the status of the order.

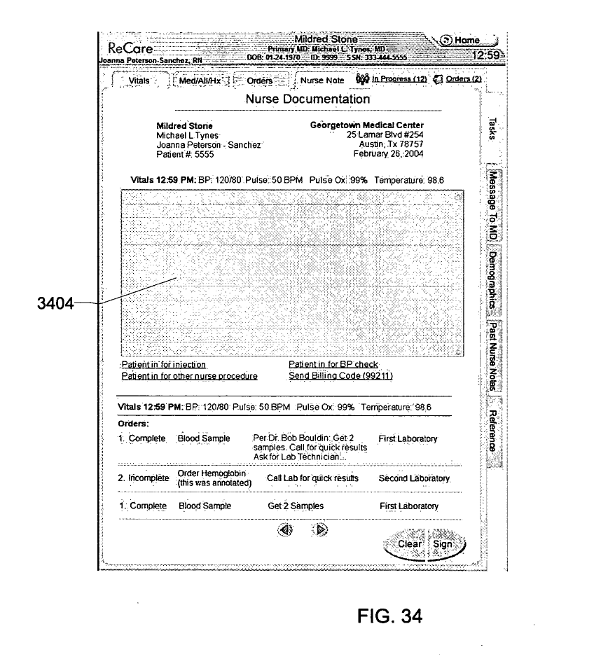

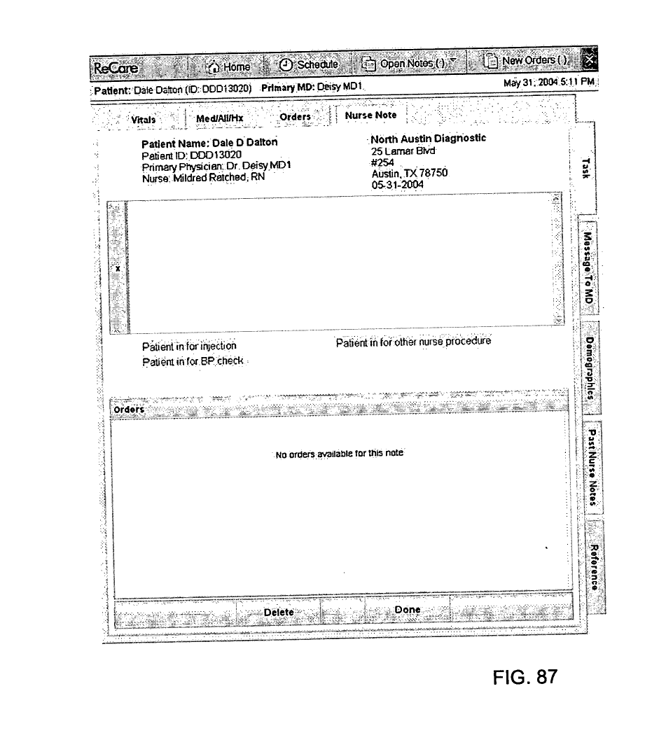

Once the nurse has completed tasks associated with the patient, the nurse may view a nurse summary document and add notes. FIG. 34 depicts an exemplary notes interface. The notes may, for example, summarize the completed tasks performed in association with a patient or patient visit and allow for annotation in annotation area 3404. The nurse may accept the information and electronically sign the note for storage in the encounter system. In one exemplary embodiment, data presented and gathered through the nurse note interface may be incorporated into a summary document presented to a physician when the physician meets with a patient. The physician interface may, for example, permit the physician to selectively enter subsequent stages in a medical workflow. In a particular embodiment, the nurse note is temporarily stored for physician review and subsequently erased. In another embodiment, when a physician does not review the nurse note or a physician note does not exist for the date of the nurse note, the note may be sent to a practice management system for use in coding for billing. FIG. 87 depicts an alternative embodiment.

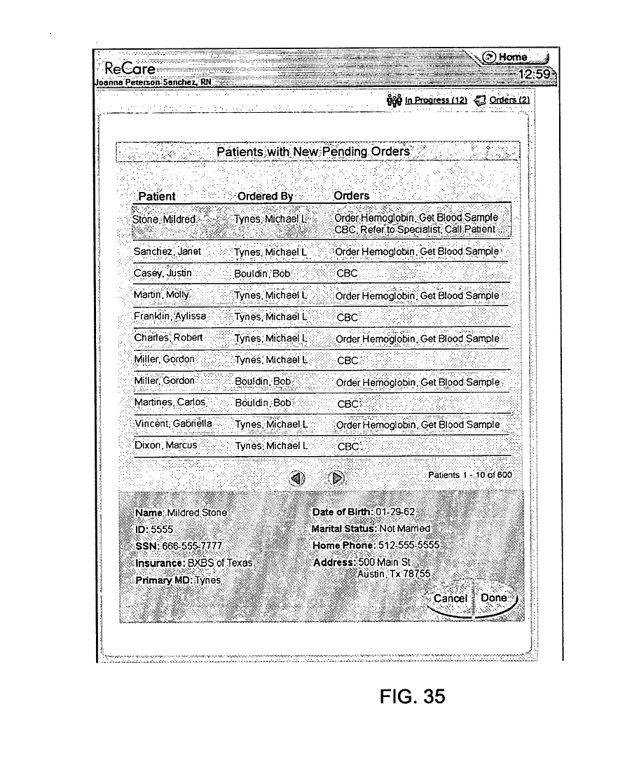

In another section of the nurse interface, the nurse may be presented with a list of patients with pending orders. FIG. 35 illustrates an exemplary pending orders interface. In this manner, a nurse may track and review pending orders.

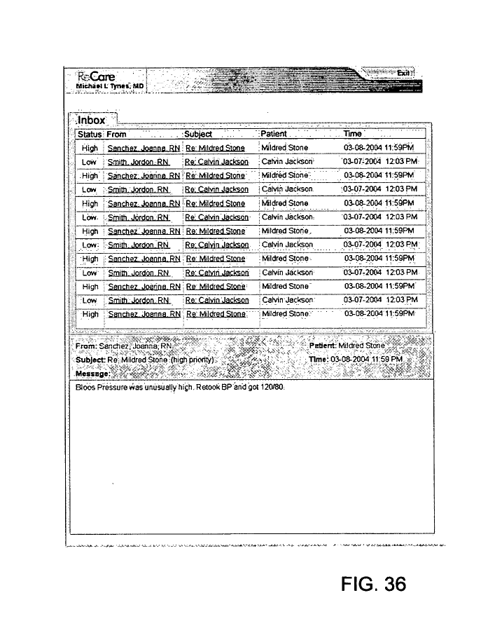

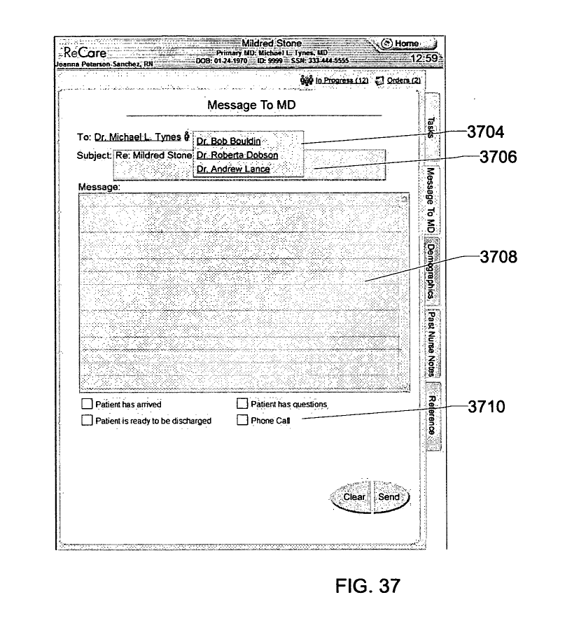

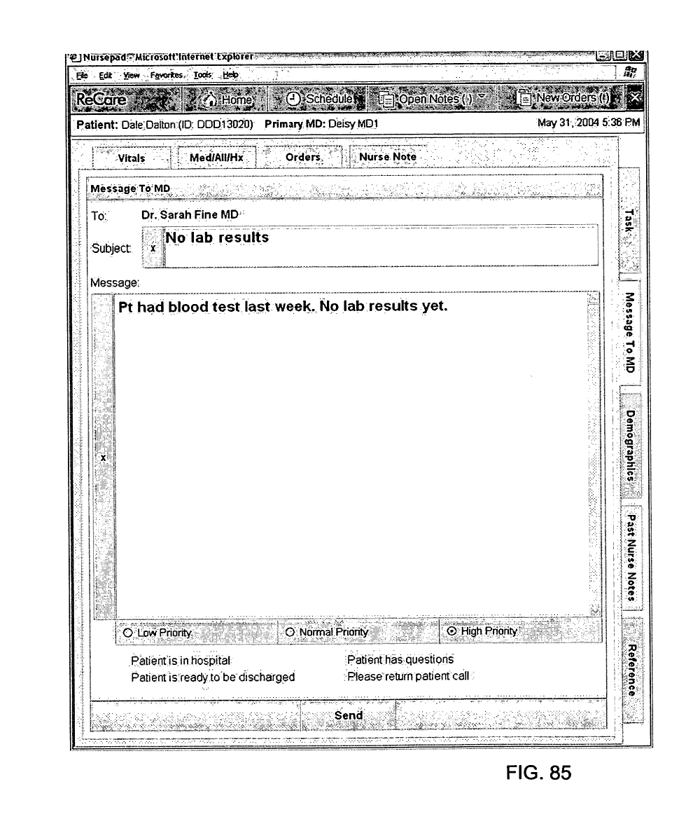

The nurse interface may also include a message queue. FIG. 36 illustrates an exemplary message queue. The message queue may be useful in communicating between a physician, nursing staff, and other medical professionals. FIG. 37 illustrates an exemplary interface for creating a message. The interface provides a drop down list 3704 for selecting the medical professional to whom the communication is addressed, a subject line 3706, and an area for text entry 3708. In addition, checkboxes 3710 may be provided with commonly used phrases or messages. A message interface may also be provided for the physician interface. FIG. 85 illustrates an alternative embodiment.

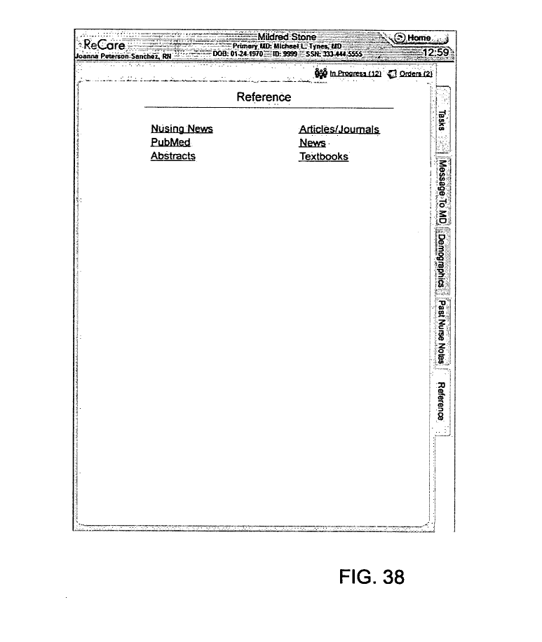

In addition, the nurse interface may include access to references, such as through an interface illustrated in FIG. 38. Through this interface, a nurse may access news, publications, abstracts, articles, journals, and textbooks. Other nurse interfaces may be provided to document phone calls, review past notes, review incomplete notes, and enter demographics information.

The nurse interface illustrated in FIGS. 24-38 may be used in conjunction with a patient interface and a physician interface to complete stages within a medical workflow. In one particular embodiment, a patient may enter chief complaint information though a patient interface. A nurse may collect data associated with the history of present illness stage, medical and allergy stage, and patient medical family and social history stage. This information may be summarized on a physician screen in which the physician is presented with the option to accept the summary or reenter portions of the previously collected data. When the physician accepts the summary, the physician may proceed to a physical examination stage. Alternatively, when the physician declines the summary, the physician may be presented with an interface associated with the chief complaint or history of present illness stages. In another embodiment, such as in cases in which limited physical examination is desired, a simple physical examination interface may be presented as part of the summary interface and the physician may proceed to a diagnosis or later stage.

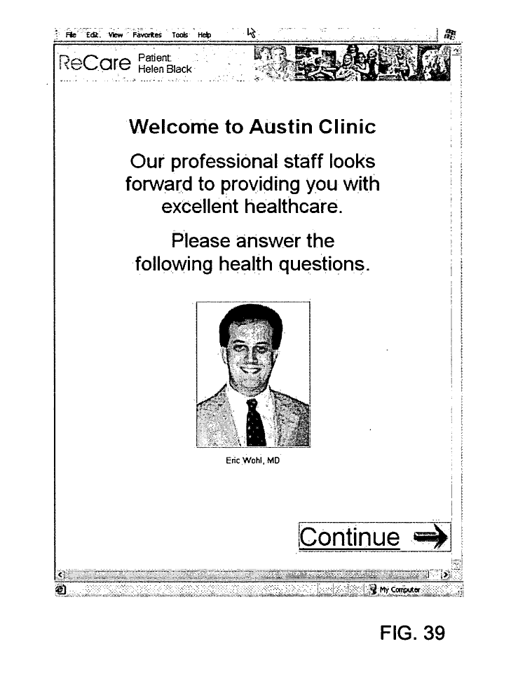

FIGS. 39 through 55 illustrate an exemplary interface for medical data entry by a patient. The patient interface may be presented on a kiosk or portable computer device and may include an entry page, such as that exemplified in FIG. 39. The entry page may, for example, identify the clinic or physician that the patient is visiting. The patient may provide identification and verify identity via an interface. In an alternative embodiment, a receptionist may enter the patient identity into a portable computer device. The device may then present an interface specific to the patient.

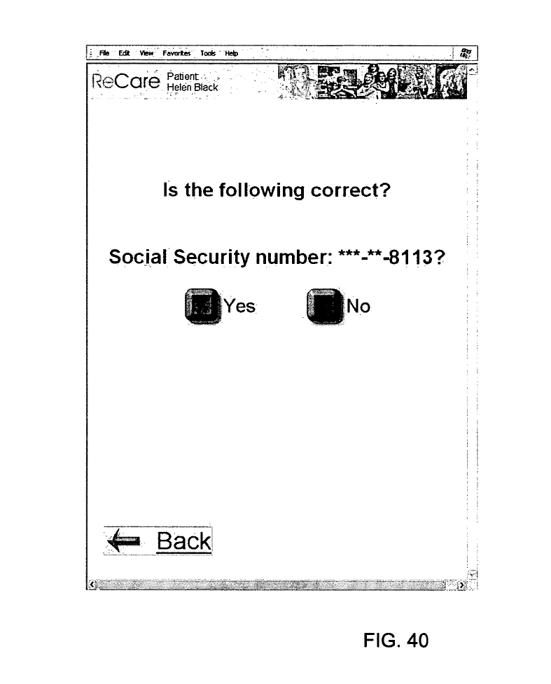

In this exemplary interface, the patient verifies their identity, such as through an interface exemplified in FIG. 40. In alternative embodiments, the patient may enter identifying information, social security information, insurance information, addresses and other identification related information.

The interface may also ask a series of questions to identify medical findings. For example, the patient may identify a chief complaint. The chief complaint interface for a patient may be associated with an underlying list of findings to be entered, such as findings associated with a chief complaint or history of present illness stage of a medical workflow. However, the patient interface may query the patient in a manner different from the nurse or physician interfaces. For example, the patient may be presented with a series of questions. The questions may be in simple terms and be associated with a reduced subset of findings. The interface may include large buttons and text and native findings language. In contrast, the physician interface may provide a dense list of findings to select, use medical terms, and be comprehensive in nature. However, both interfaces map to the same underlying information or findings. In one exemplary embodiment, patient entered findings are stored and presented in the physician interface for acceptance, modification, or deletion.

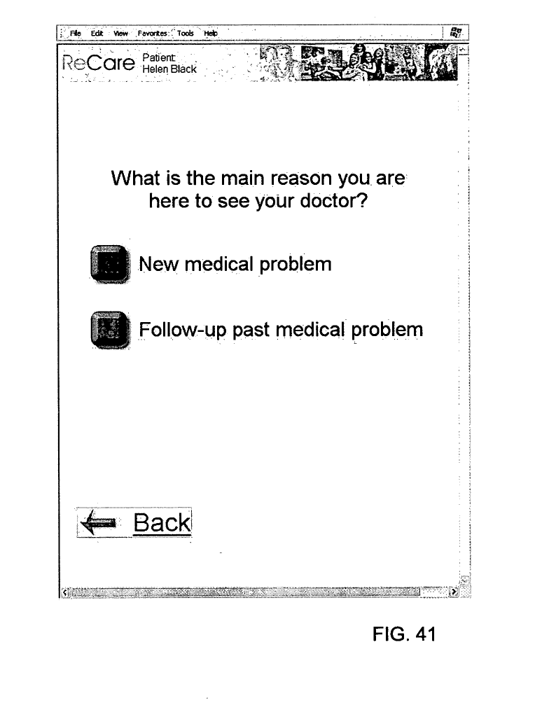

For example, in FIG. 41, the patient is asked whether the reason for the visit is a new medical problem or a follow-up visit. When the reason for the visit is to a follow-up on a previous medical problem, the patient may be asked a series of questions regarding the state of previous medical problems. When the reason for the visit is a new medical problem, the patient may be asked to identify the problem.

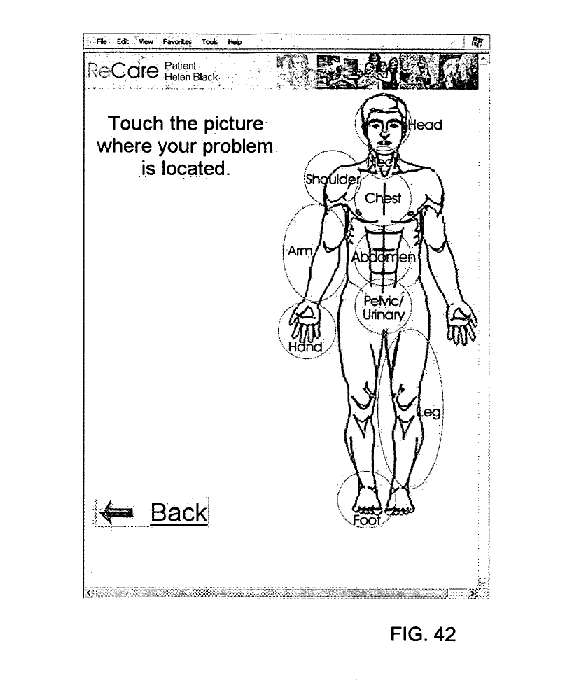

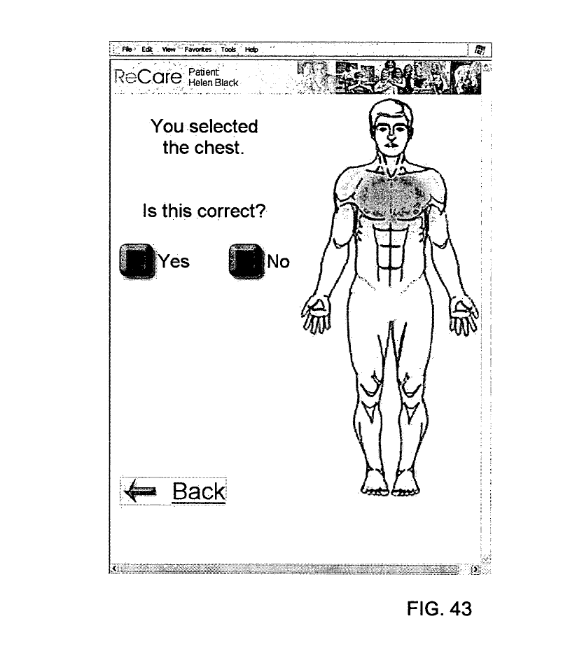

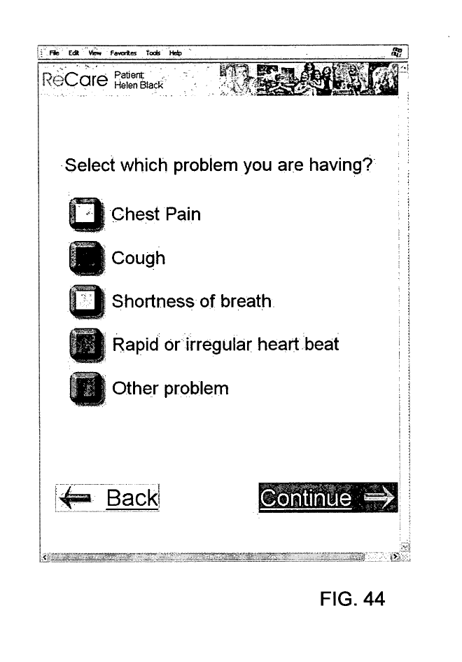

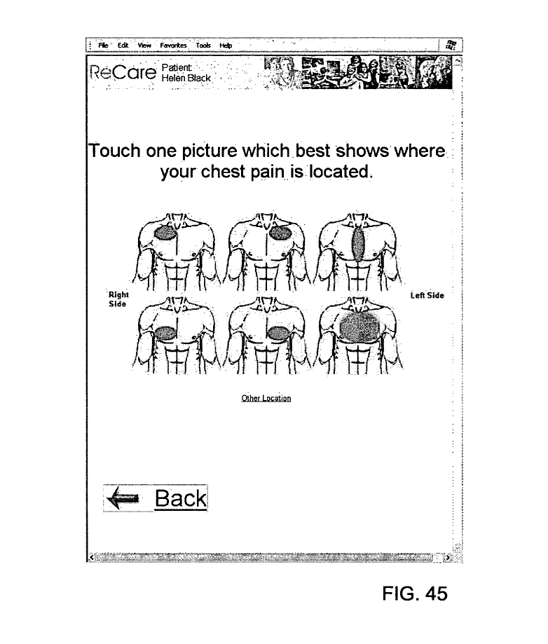

In FIG. 42, the patient is presented with a graphic. Active areas within the graphic may be used to select a problem area, such as through a touch screen display. Once the patient selects an area, such as the chest, the interface may ask a series of questions determine the complaint. For example, FIG. 43 verifies a selection. When the selection is verified, the interface identifies specific problems associated with the selection, such as illustrated in FIG. 44. In the example of FIG. 44, the patient selected chest and identifies chest pain and shortness of breath. The interface may seek additional information further identifying the chief complaint. For example, in FIG. 45, the patient identifies a narrow area in which the chest pain occurs, such as through selection of one in a set of graphics.

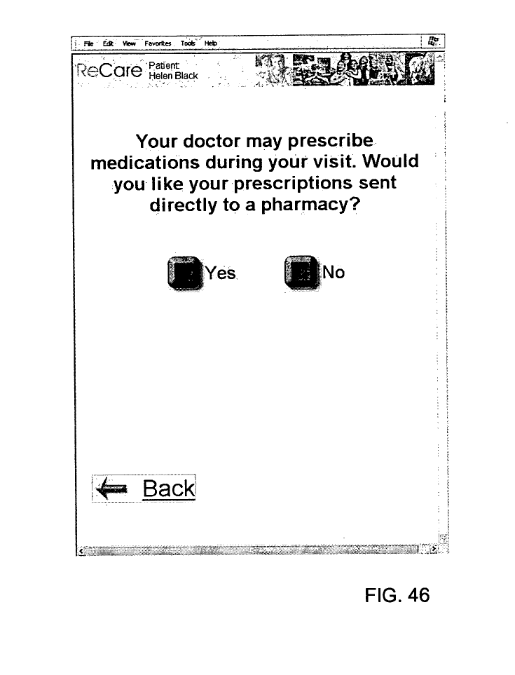

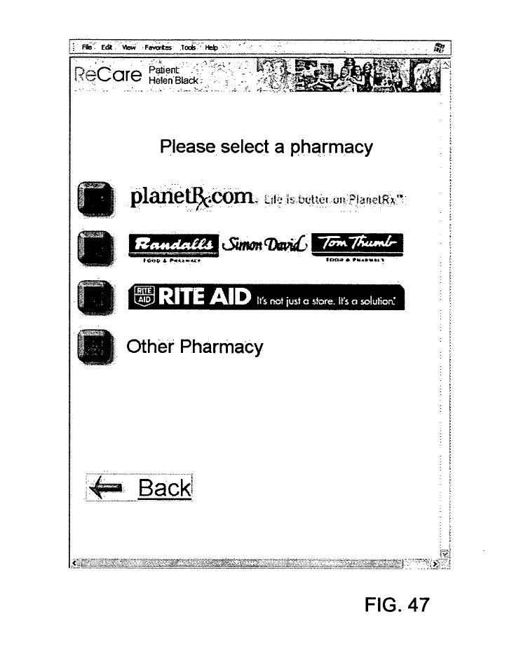

The interface may also identify patient preferences, such as the preferred location of a pharmacy. As exemplified in FIG. 46, the patient may be asked if they would like to have prescriptions sent directly to a pharmacy. When the patient answers “yes”, the patient is presented with a set of options, such as a set of pharmacy chains, as illustrated in FIG. 47. In one exemplary embodiment, the order of presentation of pharmacies may be determined by payment for advertising, the patient's address, or both.

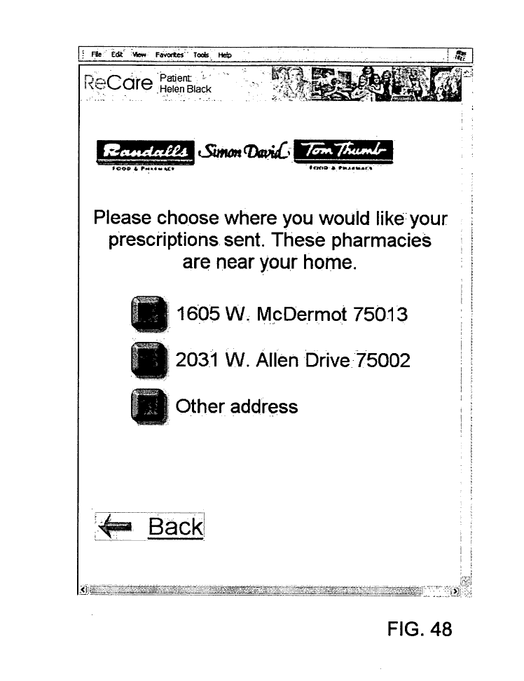

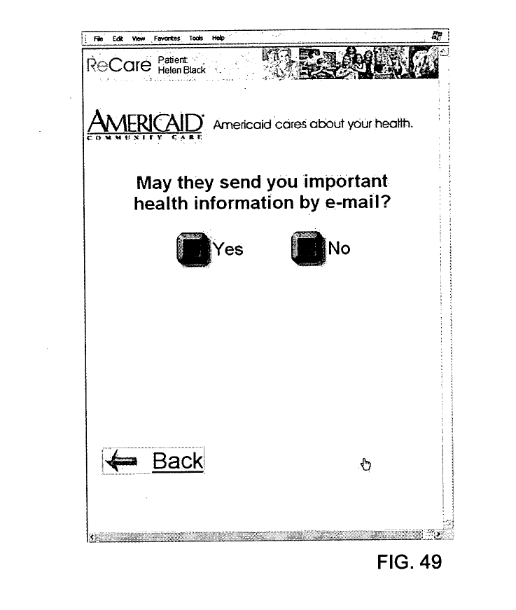

Once a pharmacy chain is selected, the patient may identify a preferred location, such as through a selection from a set of options as illustrated in FIG. 48. The patient may also be asked if the pharmacy may contact them directly, such as through email as illustrated in FIG. 49. The patient may have an email address stored on the system or may enter one when asked.

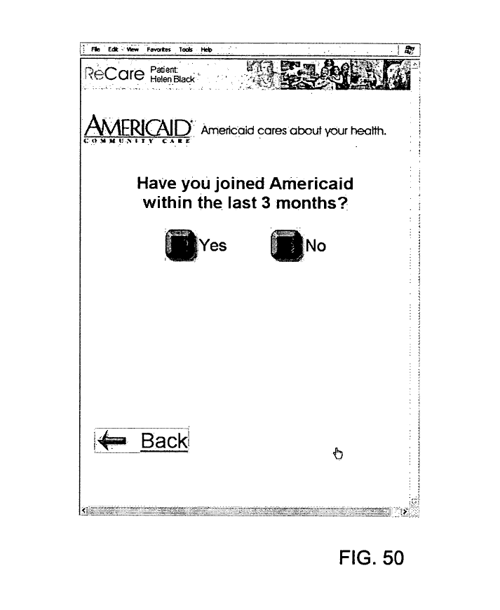

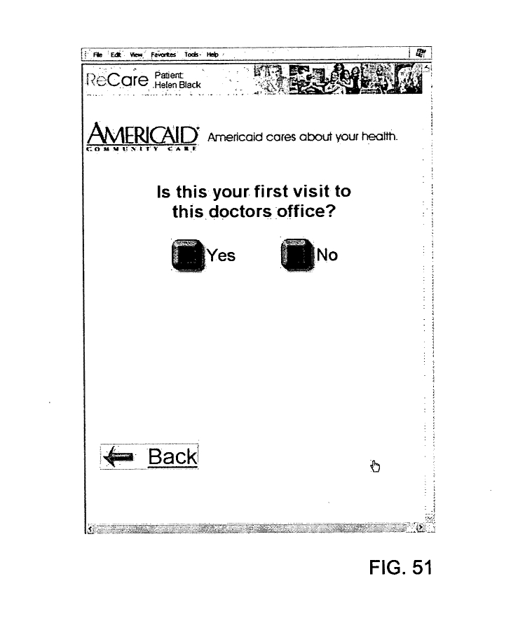

The interface may also request information associated with the insurance provider or payer. The insurance provider or payer may, for example, desire information about a newly insured patient. In one exemplary embodiment, newly or recently insured individuals may be asked to provide information to the insurance company. The question asked in FIG. 50 may determine whether the patient is newly insured. If so, the interface may determine whether the patient is continuing to see a physician seen prior to becoming insured with the payer or if this visit is with a new physician, as shown in FIG. 51. In the case of a previously seen physician, the physician's files may include desired medical history.

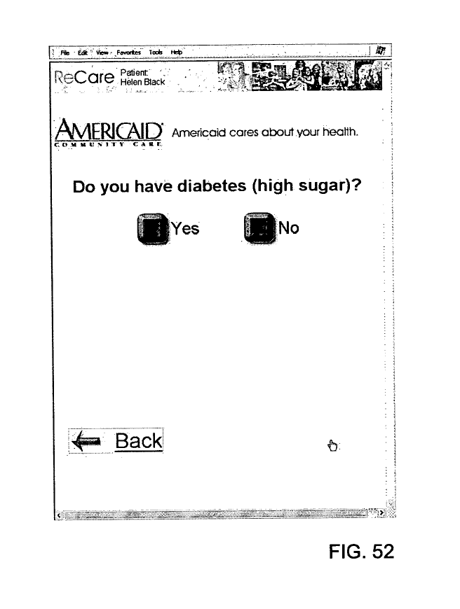

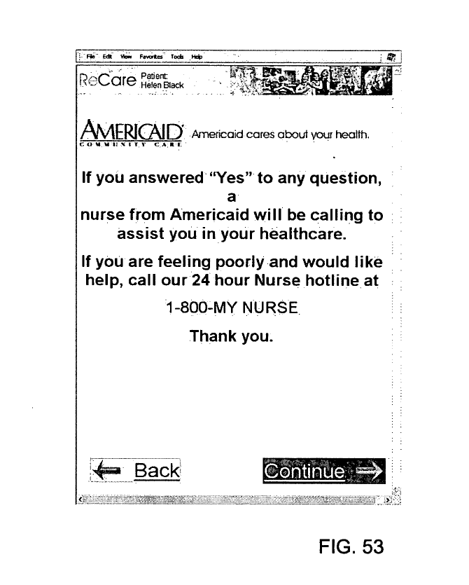

In the case of a new physician, the patient may be asked to identify past medical history. For example, the patient may be asked about conditions, such as diabetes, blood pressure, epilepsy, or other conditions. FIG. 52 illustrates a question regarding past medical history, such as diabetes. In this particular embodiment, a patient may be flagged for enrollment into a plan or program designed to track the disease and help establish disease management practices. For example, the patient may be notified that he/she is to be enrolled in a disease management program or contact by the payer, as illustrated in FIG. 53.

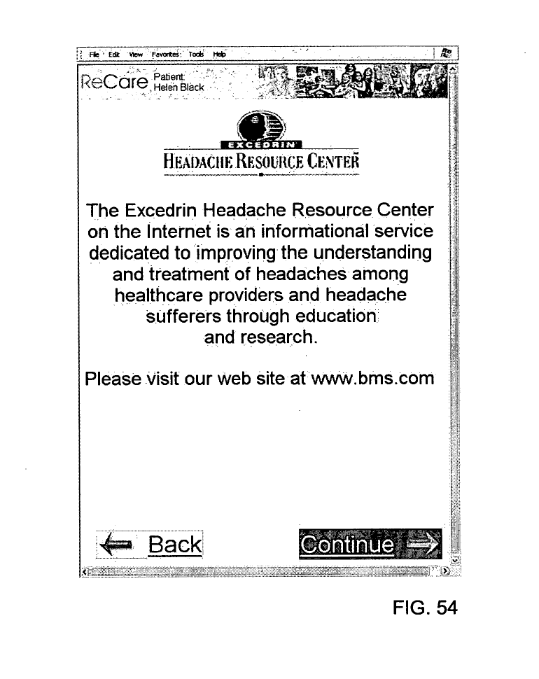

The interface may also act to provide health related information to patients. For example, patients who complain of a specific condition such as heart disease or a headache may be directed to a resource center. A medical products company, such as a pharmaceutical or medical device company, may sponsor this resource center. FIG. 54 illustrates an informational page directing a patient to a resource center related to headaches.

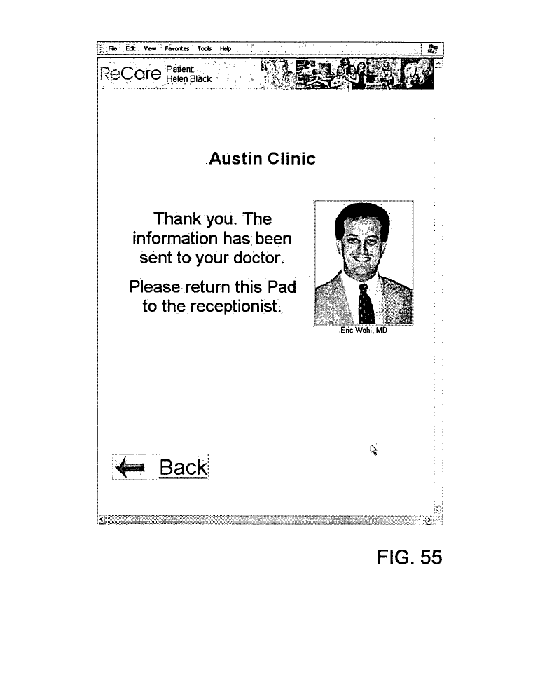

Once the patient has completed entry of medical information, the interface may provide an end message, such as a thank you message, including additional instructions. For example, in the exemplary interface illustrated in FIG. 55, a patient is asked to return a pad interface device to the receptionist and presented with a picture of the physician.

In one particular embodiment, a patient schedules a visit or enters a medical facility. Prior to seeing a medical professional, the patient may be asked to enter medical information into a patient interface. For example, the patient may be directed to a website in which they may be presented with the patient interface. Alternatively, they may enter information into a kiosk in a reception area or be presented with a pad computer device, such as a wireless pad device. The information may, for example, identify a chief complaint. After entering information, the patient may visit a nurse who, through a nurse interface, verifies the chief complaint and gathers medical data associated with the history of present illness stage of a medical workflow. The nurse may also enter vitals information through the nurse interface and identify medical and social history.

In the above embodiment, the patient entered and nurse entered information may be presented in a summary or narrative form in a physician interface. The physician interface may, for example, allow a physician to accept or decline the narrative and, in response to the accepting or declining, enter a stage in the medical workflow. For example, when the physician accepts the chief complaint and history of present illness findings, the physician may be directed to a physical examination stage. When the summary is declined, the physician may be directed to a previous stage in the medical workflow. In an alternative embodiment, the physician may modify previous findings, reducing the amount of information and time that a physician spends in determining the patient condition.

In one particular embodiment, a summary interface with the options to enter different stages in the medical workflow reduces the amount of time that a physician spends to determine a medical problem.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

1. A computer implemented method of facilitating a medical workflow, the method comprising:
receiving patient data via a first user interface device;
providing a first medical data entry interface to a second user interface device, the first medical data entry interface including at least a portion of the patient data and at least two selectable items, each selectable item of the at least two selectable items associated with a different stage within the medical workflow; and
providing a second medical data entry interface to the second user interface device in response to the selection of one selectable item of the at least two selectable items, the second medical data entry interface configured to receive data associated with the stage within the medical workflow associated with the one selected selectable item.

2. The computer implemented method of claim 1, wherein the portion of the patient data includes a medical narrative.

3. The computer implemented method of claim 1, wherein the patient data is associated with a chief complaint stage in a medical workflow.

4. The computer implemented method of claim 1, wherein the patient data is associated with a history of a present illness stage in the medical workflow.

5. The computer implemented method of claim 1, wherein the one selected selectable item is labeled “accept” and wherein the stage within the medical workflow associated with the one selected selectable item is a physical exam stage within the medical workflow.

6. The computer implemented method of claim 1, wherein the one selected selectable item is labeled “decline” and wherein the stage within the medical workflow associated with the one selected selectable item is a chief complaint stage within the medical workflow.

7. The computer implemented method of claim 1, wherein the one selected selectable item is labeled “modify” and wherein the stage within the medical workflow associated with the one selected selectable item is a history of present illness stage within the medical workflow.

8. The computer implemented method of claim 1, wherein the second medical data entry interface is associated with a physical exam stage within the medical workflow.

9. The computer implemented method of claim 8, wherein the second medical data entry interface is configured based on the patient data.

10. (canceled)

11. (canceled)

12. (canceled)

13. The computer implemented method of claim 1, wherein the first medical data entry interface provides a suggested diagnosis.

14. The computer implemented method of claim 13, further comprising determining a billing code in response to accepting the suggested diagnosis.

15. The computer implemented method of claim 1, wherein the first medical data entry interface provides a suggested medication.

16. (canceled)

17. A medical data entry interface for use with a display device, the medical data entry interface comprising:
a textual summary derived from patient medical data collected during a first stage of a medical workflow;
a first selectable item that when selected provides access to a first interface associated with the first stage of the medical workflow, and
a second selectable item that when selected provides access to a second interface associated with a second stage of the medical workflow.

18. The medical data entry interface of claim 17, wherein the first interface is configured for modifying the patient medical data.

19. The medical data entry interface of claim 17, further comprising a third selectable item configured to access a third interface associated with a third stage of the medical workflow.

20. The medical data entry interface of claim 17, further comprising a medication item with an associated acknowledgement element.

21. (canceled)

22. (canceled)

23. (canceled)

24. The medical data entry interface of claim 17, further comprising a suggested physician plan area.

25. The medical data entry interface of claim 17, wherein the first stage includes a chief complaint stage.

26. The medical data entry interface of claim 17, wherein the second stage includes a physical exam stage.

27. A medical data entry device comprising:
a processor, and
storage accessible by the processor, the storage including:
an medical data entry interface including:
a textual summary derived from patient medical data collected during a first stage of a medical workflow;
a first selectable item that when selected provides access to a first interface associated with the first stage of the medical workflow; and
a second selectable item that when selected provides access to a second interface associated with a second stage of the medical workflow.
